(19) United States
(12) Patent Application Publication
(10) Pub. No.: US 2010/0262464 A1
(43) Pub. Date: Oct. 14, 2010

(54) ACTIVE LEARNING AND ADVANCED RELATIONSHIP MARKETING

(75) Inventors: Jeffrey J. Monteforte, Seven Hills, OH (US); Greg Muffler, North Royalton, OH (US); Dennis J. Gaukin, Broadview Heights, OH (US)

Correspondence Address: TUROCY & WATSON, LLP, 127 Public Square, 57th Floor, Key Tower, CLEVELAND, OH, 44114, US

(73) Assignee: ACCESS MOBILITY, INC., Cleveland, OH (US)

(21) Appl. No.: 12/426,460

(22) Filed: Apr. 20, 2009

Related U.S. Application Data
(63) Continuation-in-part of application No. 12/421,321, filed on Apr. 9, 2009.

(51) Int. Cl. G06Q 30/00; G06F 17/30; G06F 17/40; G06Q 10/00

(52) U.S. Cl. 705/10; 707/E17.017; 707/E17.044; 705/14.65; 705/14.38

(57) ABSTRACT

Active learning and advanced relationship marketing are employed with respect to a mobile marketing system. A relationship between an advertiser and a consumer can become smarter over time as a function of interaction as well as non-interaction. Further, affinity groups or micro segments can be identified to aid tailoring of advertisements to consumers. Consumers can additionally be engaged in a dialog to acquire additional information and/or feedback data to develop a further understanding of specific consumers. Still further yet, assistance can be provided to advertisers so that advertisements can be customized for needs of potential customers.

### CROSS REFERENCE TO RELATED APPLICATIONS

This application is a continuation-in-part of application Ser. No. 12/421,321, filed Apr. 9, 2009, and entitled “CONTEXT BASED MOBILE MARKETING,” which is incorporated herein by reference.

### BACKGROUND

Mobile devices continue to be wildly popular amongst most people. In the not so distant past, mobile devices where confined to bulky cell phones, pagers, and personal digital assistants (PDAs) utilized primarily for business purposes. Advances in technology and reductions in cost created much smaller and affordable devices, such that nowadays most everyone owns at least one mobile device. For instance, mobile phones, music players, and global positioning system (GPS) devices, gaming systems, and electronic book readers are increasingly pervasive. Furthermore, smart phones and other hybrid devices are becoming very popular since they provide a combination of functionality in a single device.

Marketing and more specifically advertising has changed over time with technology. At one time, television, radio, and mail were the primary means for advertising. Accordingly, advertising was accomplished by way of commercials and direct mailings. With the advent of the Internet, advertisers were afforded additional dissemination mechanisms including e-mail and search. Consequently, advertisements are now also provided in the form of or within e-mail, embedded with Web pages, and proximate to or as search results, among other things. The proliferation of mobile devices now provides advertisers with yet another way to reach potential customers. Further yet, advertisers are now seeking to exploit location information enabled by many mobile devices. Such functionality is often referred to as a location-based service (LBS) or alternatively location-based advertising (LBA). Location-based services supply information as a function of the geographical position of a mobile device. One or more location mechanisms can be utilized by such services including GPS, triangulation, and local proximity technologies such as Bluetooth, infrared, wireless local area network (WLAN), and radio frequency identification (RFID), among other things. Applications can then utilize the determined location to aid navigation or focus search results. Moreover and as previously mentioned, advertisements or the like can be transmitted to users based on their location as determined via their mobile device. For example, when a mobile phone is determined to be within a specified distance of a restaurant, a text message can be sent to the user including a promotional code associated with some discount, such as 10% off a meal or a free appetizer with the purchase of two entrees.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains generally to active learning and advanced relationship marketing in the context of a marketing system or service. Here, mechanisms are provided for engaging consumers in an ongoing dialog with a mobile marketing system or service to collect pertinent information. Dialog information amongst other acquired information such as transactional activity can be utilized to form a learning relationship between a consumer and advertiser that develops and changes over time with every interaction as well as non-interaction. Consequently, advertisements can be increasingly tailored and consumers are more precisely differentiated.

In accordance with a particular aspect of the disclosure, affinity groups or the like can be formed, and consumers can be moved into or out of groups as a function of newly acquired information, for instance. Predictions about what a consumer is likely to need or desire can then be made based on group membership. In this manner, an advertisement can be identified and provided to a consumer based on a likely need or desire of which the consumer is not yet aware.

According to yet another aspect, advertisement assistance can be provided with respect to generating precisely targeted advertisements based at least in part upon a vast collection of knowledge acquired. By way of example and not limitation, recommendations can be made to advertisers upon detection of an unmet need or desire to facilitate generation of an advertisement that addresses the need or desire. Additionally, concept testing can be performed and advertiser questions answered.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a mobile marketing support system in accordance with an aspect of the disclosed subject matter.

FIG. 2 is a block diagram of a representative dialog component according to a disclosed aspect.

FIG. 3 is a block diagram of a representative analysis component in accordance with an aspect of the disclosure.

FIG. 4 is a graphical illustration of predictive analysis according to a disclosed aspect.

FIG. 5 is a block diagram of a representative advertisement component in accordance with an aspect of the disclosure.

FIG. 6 is a block diagram of a mobile marketing system in accordance with an aspect of the subject disclosure.

FIG. 7 is an exemplary environment in which the mobile marketing system of FIG. 6 can be employed according to an aspect of the disclosure.

FIG. 8 is a block diagram of a representative context component in accordance with a disclosed aspect.

FIG. 9 is a block diagram of a representative consumer interface component according to a disclosed aspect.

FIG. 10 is a block diagram of a representative advertiser interface component in accordance with an aspect of the disclosure.

FIG. 11 is a block diagram of a representative correlation component in accordance with an aspect of the disclosed subject matter.

FIG. 12 is a block diagram of a representative delivery component according to a disclosed aspect.

FIG. 13 is a block diagram of a representative consumer interface component according to a disclosed aspect.

FIG. 14 is a flow chart diagram of a method of actively collecting information from users according to an aspect of the disclosure.

FIG. 15 is a flow chart diagram of a method data analysis in accordance with a disclosed aspect.

FIG. 16 is a flow chart diagram of a data analysis method according to an aspect of the disclosure.

FIG. 17 is a flow chart diagram of a method of assisting an advertiser in advertisement generation in accordance with a disclosed aspect.

FIG. 18 is a flow chart diagram of a method of concept testing in accordance with an aspect of the disclosure.

FIG. 19 is a flow chart diagram of a method of advertiser inquiry according to a disclosed aspect.

FIG. 20 is a flow chart diagram of a method of mobile advertisement in accordance with an aspect of the disclosure.

FIG. 21 is a flow chart diagram of a method of employing advertisements in accordance with a disclosed aspect.

FIG. 22 is a flow chart diagram of a method of offer redemption in accordance with a disclosed aspect.

FIG. 23 is a flow chart diagram of a method of advertising as a function of calendar entries according to a disclosed aspect.

FIG. 24 is a flow chart diagram of a method of advertisement distribution according to an aspect of the disclosure.

FIG. 25 is a flow chart diagram of a method of advertising based on behavior model according to a disclosed aspect.

FIG. 26 is a flow chart diagram of a method of group advertising in accordance with an aspect of the disclosed subject matter.

FIG. 27 is a schematic block diagram illustrating a suitable operating environment for aspects of the subject disclosure.

FIG. 28 is a schematic block diagram illustrating a suitable operating environment for aspects of the subject disclosure.

FIG. 29 is a schematic block diagram of a sample-computing environment.

### DETAILED DESCRIPTION

Systems and methods pertaining to active learning and advanced relationship marketing described in detail hereinafter. Feedback and customization capabilities make it possible to provide a bridge for advertisers to interact with potential consumers. Feedback or other information can be actively collected from consumers by engaging them in a dialog that is designed to extract pertinent information. Such dialog information in conjunction with other information such as transactional activity can produce a learning relationship between advertisers and consumers that can change over time as a function of interaction as well as non-interaction, among other things. This relationship learning capability enables advertisements to be increasingly tailored and a consumer more precisely differentiated from other consumers. Furthermore, a variety of analytics can be executed with respect to acquired data. For instance, affinity groups or the like can be generated and employed to make predictions about consumer needs or desires. Still further yet, collected or learned information can be utilized to assist advertisers in generating precisely targeted advertisement that produce unprecedented levels of response and return on investment while also improving customer loyalty.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

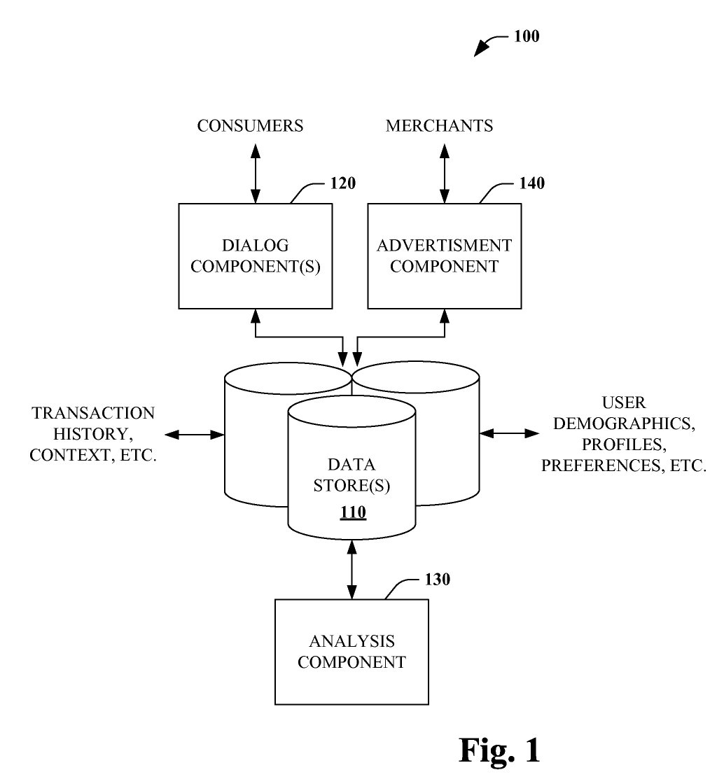

Referring initially to FIG. 1, a mobile marketing support system 100 is illustrated in accordance with an aspect of the claimed subject matter. In particular, the system 100 includes one or more data stores 110 that house advertiser and user or consumer information, among other things. For example, such information can include, without limitation, demographic information, context information (e.g., location, extrinsic data . . . ), transaction history, and/or personal health data. The information can be acquired by an associated system, component thereof or a third-party service. Furthermore, information can be produced as a function of other information or data. As will be described in further detail infra, information persisted to one or more data stores 110 can be employed to facilitate matching of advertisements to users with respect to a mobile marketing system.

The system 100 can also include one or more dialog components 120 (e.g., online, mobile device . . . ) communicatively coupled with data store(s) 110. A dialog component 120 engages a user or consumer in a dialog to acquire pertinent information that can aid a mobile marketing system. More specifically, the dialog component 120 can acquire additional information, or feedback, from users including, without limitation, opinions, attitudes, likes, dislikes, and preferences. Further, feedback can be specified with respect to a mobile marketing system, an advertiser, an advertisement, and/or a product or service, among other things. While a user can explicitly enter information such as a profile, preferences, or settings, for example upon mobile marketing system setup, the dialog component 120 allows information to be continually collected, for example upon naturally occurring events, among other things. Furthermore, it should be appreciated that such customer feedback data can be integrated with transaction data and member profile and preference information to facilitate predictive analytics so that a resulting analysis include a complete understanding of member preferences, motivations, and intentions, as will be described further infra.

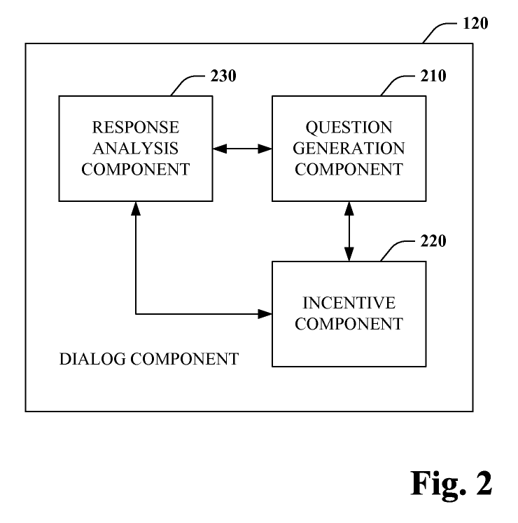

Turning attention to FIG. 2, a representative dialog component 120 is depicted in accordance with an aspect of the claimed subject matter. As shown, the dialog component 120 includes a question generation component 210, an incentive component 220, and a response analysis component 230.

The question generation component 210 generates or otherwise acquires questions for presentation to a user. For example, such a question could be “On a scale of 1-5, how would you rate your experience with a particular retailer?” or “How would you rate a provided offer?” In another embodiment, the question generation component 210 can produce a rating bar or like response tactic that can be employed to allow members to indicate their personal attitude, opinion, and/or satisfaction with an item, among other things. The rating bar tactic call use a displayed continue or next button that is represented by a continuous scale of colors progressing from green to red. This provides a richness of feedback without adding complexity to the user interface or interaction process.

The incentive component 220 can provide one or more mechanisms that encourage a user to participate in a dialog or to converse with a marketing system. A modest incentive can increase response rates dramatically. For instance, at a restaurant, a user can be asked to rate the food and/or service, and to encourage a response the incentive component 220 can offer a coupon to the user for a discount off the bill. In another instance, a user can be entered into a drawing for something such as a gift card, a car, or a vacation package. In this manner, a user can be encouraged to answer more than a current set of questions. Rather, the user is encouraged to continue dialog to increase the chances of winning some prize.

Of course, various other incentives or rewards can be employed to encourage user participation or investing in a relationship with a mobile marketing system. By way of example and not limitation, the incentive component 220 can also provide game functionality to motivate users to engage in a dialog. As an example, a user may earn points for responding to inquires and users can strive to obtain a high score. Users can also be pitted against one another to compete for the best score, wherein the users are motivated by pride and/or a particular prize.

Further yet and in accordance with one embodiment, the incentive component 220 can ensure that incentives do not introduce respondent bias, where some members become more likely to respond than others do. The secret is to offer an incentive with universal appeal that all members may find equally attractive. Typical universally desired incentives include, without limitation, 1) entry into a prize drawing for an item or a cash prize; 2) award of points in a Rewards Program where the points can be redeemed for a promotional item with a mobile marketing system corporate logo, which not only encourages participation but also has a marketing and brand awareness advantage; 3) access to a small digital download, such as a ringtone, mobile video game or song; and 4) recognition in a “Members of the Week” section program. Additionally, when people feel they have an important stake in the types and quality of service offered they will often participate simply because it is in their own long-term best interest.

The response analysis component 230 can receive, retrieve or otherwise obtain or acquire a response to a question as well as analyze that response. For example, the component 230 can determine whether the response is valid, acceptable, and/or appropriate. Furthermore, the response analysis component 230 can work together with the question generation component 210 to enable intelligent follow-up questions to be asked and/or modification of the form of a question, for instance as a function of responses. Among other things, this enables more open-ended questions to be presented to a user, since the response analysis component 230 can interpret any response rather than simple scalar ratings. By way of example, consider gathering of feedback information about an offer. After a user has rated an offer, a subsequent question can be sent to the user concerning what the user liked or disliked about the offer based on the rating. Further, the user can be asked how the offer could be modified to make it more appealing to them or the like. It is also to be noted that the response analysis component 230 can be coupled to the incentive component to ensure that incentives are provided for responses or particular types of responses.

It is to be appreciated that the dialog component 120 or subcomponents thereof can be context aware. Accordingly, dialog can further utilize contextual information with respect question generation and the like. By way of example, the dialog component 120 can detect or infer a device that a user is employing and control the type or style of inquiry. For instance, where the device is a mobile device such as a phone, the dialog component 120 can utilize seek to acquire small discrete pieces of information utilizing one-off questions like rankings (e.g., rate experience on a scale of 1-10). Alternatively, if a user is employing a desktop computer or laptop a much more robust conversation can be initiated. For example, a survey or the like can be designed to build a robust three hundred and sixty degree view of the user.

However, accordingly to one embodiment, surveys can incorporate a 5-point Likert scale (or “category identifier”) with a representative scale of: (5) Very satisfied, (4) Somewhat satisfied, (3) Neither satisfied nor dissatisfied, (2) Somewhat dissatisfied, (1) Very dissatisfied. Key features of this scale are that it is symmetrical and avoids descriptors with strong emotional connotations. A similar scale will be utilized to measure agreement with certain statements or likelihood to take certain future behaviors.

Additionally, contextual information can be employed to control the timing of requests for feedback. Properly timed customer satisfaction surveys ratings or the like will obtain additional, valuable topics of interest to advertisers including, quality of customer service, pricing versus competitors, product-level satisfaction, likelihood to recommend, and likelihood to repurchase. Generally, member inquires can be conducted frequently enough to keep a “pulse” on members sentiments, thus allowing a mobile marketing system to make improvements to processes on a continual basis. For example, a survey can be conducted at a particular time after a specified promotion or marketing campaign, while the experience is still fresh on consumers' minds. In other words, questions can be asked on, after or during naturally occurring events, among other things.

Furthermore, context information can be associated with questions and answers such that preferences, opinions or the like can be context dependent. For instance, it can be determined or inferred from dialog with a user, that when a user is at home on Sundays, he/she prefers Italian food when the temperature is below fifty degrees Fahrenheit; otherwise, he/she has a preference for grilled food.

Overall, it is to be appreciated that the dialog component 120 can provide a natural, non-threatening, and even encouraging mechanism for conducting an ongoing, deep, and rich dialogue with consumers. Further, users or consumers can help a mobile marketing system, along with its advertisers, target new system members and prospects, among others. Beginning with standard market research available for purchase to most firms, allows a mobile marketing system to determine member groupings by demographic and psychographic characteristics among other things. However, this level of analysis does not allow a promotional offer to be customized to match the requirements of a micro-segment or an individual. In order to create a learning relationship, a continuous feedback link and dialogue between a mobile marketing system and its members can be established.

Electronic channels, such as email, web site, and online surveys are at a system's disposal to invite dialogue from its members. In addition, emerging mobile technology advancements can be imbedded into a delivery channel that can take advantage of GPS location tracking and mobile interactions and replies, to continually poll members for essential, yet discrete pieces of data and feedback. These dialogue channels are preferred because of their inherently low cost and increased response capability. For example, a standard approach for obtaining customer preferences by manufacturers is the use of warranty cards. In truth, the production of warranty cards, their inclusion in product packaging and the cost of prepaid postage causes the use of warranty cards to greatly exceed the described alternative approaches. Moreover, the number of customers who actually return warranty cards is typically less than ten percent—far below the anticipated response rate of dialogue contacts.

Stated differently, in today's “connected” society better response rates are typically associated with online surveys rather than paper surveys thanks to strong Internet penetration and technically savvy users. Respondents usually prefer the online format due to convenience, ease of survey completion, and lower time requirements. As for the actual boost expected from the dialogue approach, for response rate going from paper to online, the boost depends on the target audience. For examples because of their high propensity to using the online channel, if 18-26 year old males are surveyed, it is expected that a much larger boost would be seen than if the elderly were surveyed.

Although preferred, the claimed subject matter is not limited to an online format. In fact, paper surveys can be mailed to those users that prefer such interaction. Subsequently, such information can be entered or scanned into the system and associated with the particular user who completed the survey.

Motivating users or members to complete an online customer survey is always a challenge, but various best practices as well as innovative and contemporary methods can be employed to improve survey response rates dramatically. For instance, to encourage a maximized survey response rate, three main factors can be considered, namely, survey length, incentives, and communications.

There is a strong, inverse relationship between survey length and response rates. Accordingly, short, but more frequent, feedback and, survey techniques can be utilized. For example, member feedback and survey initiatives can be limited to no more than ten questions in length, when performed online and no more than three questions when performed on a mobile device. This policy of survey length translates into an average of about one to two minutes of member time. However, that assumes a variety of different, question formats dealing with separate aspects of the customer experience, but if the questions are all in a similar format and can be completed more quickly a longer questionnaire c an be employed. Of utmost importance is survey completion time.

Furthermore, it should be appreciated that to encourage more detailed survey responses, open-ended survey questions should be worded properly. For example, it is better to ask, “What are three ways that Company XYZ can serve you better?” than “How can Company XYZ serve you better?”

To achieve statistically valid results, the system dialog component can strive to achieve a statistically significant sample of n=400 completed surveys for online market research surveys. This will provide statistical validity at the 95% confidence level with +/−5% confidence interval. Initially, when the member base is small, a sample of n=200 completed surveys can be utilized, which provides statistical validity at the 95% confidence level with +/−7% confidence interval.

The dialog component 120 can also ensure proper-targeted respondent sampling Panels of survey respondents can be identified and utilized that closely mirror the United States population in terms of gender, region, race, and household income per the latest US Census data. If requested by an advertiser, the dialog component 120 can generate a sample targeted at a particular demographic or behavioral subgroup. Accordingly, a guarantee can be made to advertisers that all survey quotas will be met at a fixed cost per completed survey.

There has been an observed response bias in customer satisfaction surveys towards the customers on either extreme of the satisfaction scale, particularly those who are very dissatisfied. In other words, very satisfied or dissatisfied customers are more likely to respond to a survey invitation than those more towards the middle. Sampling and survey administering tactics can combat the resulting “polarization” of customer survey data by assuring the maximum survey response rate possible, thus capturing more of the ambivalent customers and making the customer survey responses more representative of the overall customer base.

Further still, since a mobile marketing system is transactional in natured, the dialog component 120 can make use of a perpetual survey in one embodiment where respondents are asked, to complete the survey immediately after a transaction. Regardless of survey administration frequency, a single respondent should not be asked to participate more than once a week, for example, to avoid respondent fatigue.

Returning briefly to FIG. 1, the marketing support system 100 includes an analysis component 130 communicatively coupled to the data store(s) 110. The analysis component 130 can execute various analytics or logic over various data including consumer profiles, preferences, and purchasing behavior to help advertisers drive highly targeted and effective advertisement campaigns and provide consumers with precisely tailored advertisements. Although not limited thereto, in one embodiment, the analysis component 130 can identify community likeness, affinity grouping, and/or market or micro segmenting.

A cornerstone of the desired learning relationship is having members that teach the marketing system about their specific needs. In other words, the system does not solely rely on information about the member (e.g., purchased demographic data) but on information from members. This insight enables the marketing system to convert a sale from a one-time event into a continuous iterative process.

A significant long-term advantage for the subject marketing system is not competing on the size of membership base but on the scope of the relationship maintained with an individual member. In a battle for building loyal, repeat members with significant lifetime value (LTV), the successful mobile marketing system will not be the one with the most members, but the one with the most knowledge about individuals' wants and preferences.

By integrating community likeness analysis, the marketing system will be in a position to anticipate what a particular member wants, even before she realizes she wants it. Community likeness analysis is enabled by accumulating information about the whole community of members' tastes, needs, and preferences.

The power of community likeness is considerably leveraged when a member requests something significantly different from what is in the member's previously accumulated profile and behavior pattern. Specifically, this aspect will alert the member that this is a new aspect of her behavior that has been learned or inferred. The member's information can then be automatically updated and/or updated with approval by clicking on a link, for example. In one instance, this can arise when the member has performed a search across all offers and has activated an offer that was not sent to her because it did not satisfy the member's current profile and preference settings. Additionally or alternatively, the analysis component 130 can perform predictive analysis in a further attempt to obtain a complete understanding of members.

In essence, members can be provided with a proactive marketing agent that acts in the best interest of the member by leading the member to an offer for a product that has been determined or inferred to be likely of need to the member, while the member is unaware of this need. For example, if over seventy percent of the member's community (e.g., members who spend a significant amount of time in their cars, because of work related sales activity) purchased an in-car power cord for a newly released cell phone, then there is a high propensity that this member will also have a need for the in-car power cord—if she only knew that it was not included with the purchase of the phone and that there was an active offer for the product.

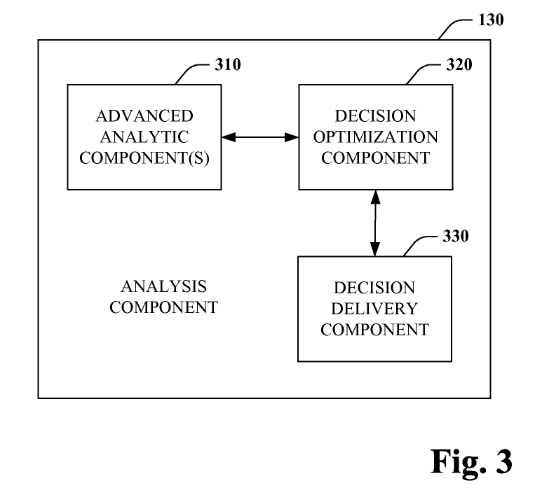

Turning attention to FIG. 3, a representative analysis component 130 is illustrated in accordance with an aspect of the claimed subject matter. Overall, the analysis component 130 can seek to provide actionable data that facilitates highly tailored and precise advertisement matching. In furtherance thereof, the analysis component 130 includes advanced analytic component(s) 310, decision optimization component 320, and decision delivery component 330. The advanced analytic component(s) 310 execute statistical, mathematical, and/or other algorithmic techniques that are used to examine the way in which specific issues relate to data on past, present, and future actions. The decision optimization component 320 analyzes actions to determine which actions will drive optimal outcomes. These “optimal actions” are delivered by the decision delivery component 330 to particular individuals, entities, systems, or the like that can perform the actions. In other words, the analysis component 130 can engage in predictive analysis to among other things reduce marketing costs, improve marketing return on investment, improve customer loyalty, and provide customer intimacy.

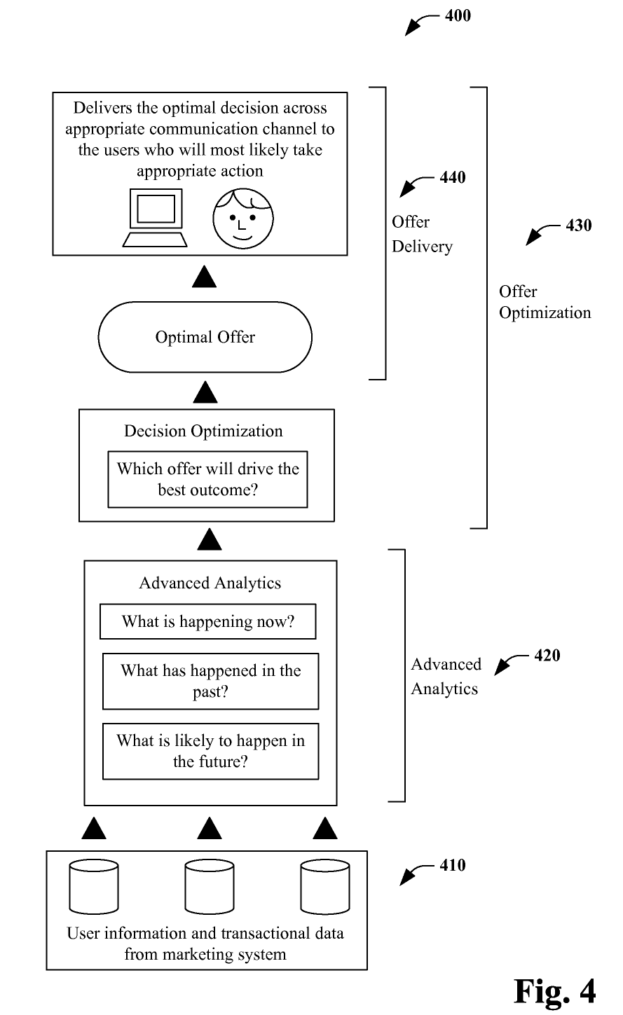

FIG. 4 provides a graphic illustration 400 of employment of predictive analysis in accordance with an aspect of the claimed subject matter Information from the marketing system 410 can be analyzed utilizing advanced analytics 420. In particular, what is happening now, what as happened in the past and what is likely to happen in the future is determined and/or inferred from user information and transactional data from the marketing system, among other things. For example, it can be determined that it is a warm summer morning and a user is in the proximity of a coffee shop. In similar circumstances in the past, the user has purchased an ice coffee. Accordingly, it can be predicted that the user might again like to purchase an iced coffee. Offer optimization 430 can then be performed to determine the specifics to an offer that will drive the best outcome. In the ongoing example, providing a user with an advertisement alone or in conjunction with a discount offer would drive the outcome of encouraging a purchase. Offer delivery 440 can subsequently deliver the advertisement across appropriate channels to particular users who will most likely perform a desired action.

Of course, this is an over simplified example of the capabilities of predictive analysis meant solely to aid in understanding. The predictive analysis can perform much more sophisticated operations, for example to identify seemingly unconnected items to a user. For instance, it may be determined that an iced coffee drinker is likely to have an interested in a particular pastry or book. The predictive analysis can thus identify an anticipated need or desire of which a consumer is unaware. Furthermore, as will be described below, the predictive analysis can aid advertising campaign recommendation and answering of business questions particular questions.

Returning briefly to FIG. 1, the support system 100 also includes an advertisement component 140 communicatively coupled with the data store(s) to help advertisers produce effective advertising campaigns. More specifically, the advertisement component 140 can employ information or data housed in the data store(s) 110 to provide advertisers valuable insight into the needs of potential consumers and help advertisers avoid costly mistakes such as by introducing a new line of goods or developing a costly marketing campaign that no one really wants.

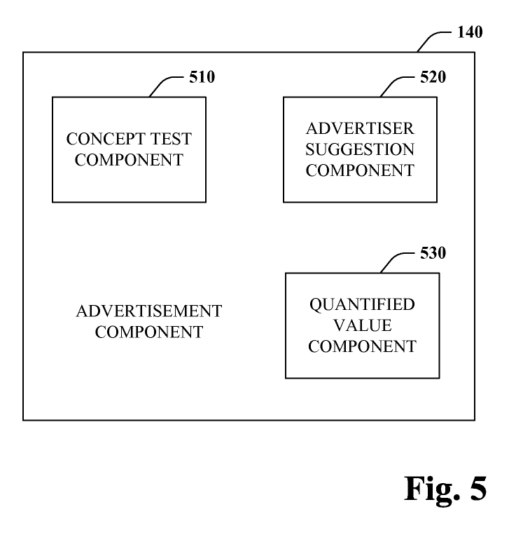

Referring to FIG. 5, a representative advertisement component 140 is shown according to an aspect of the claimed subject matter. The advertisement component 140 includes a concept test component 510 that facilitates testing of advertisements. Rather than simply designing an advertisement or advertising campaign and implementing it, the advertisement can first be tested. More specifically, and as will be described further with respect to a particular marketing system, the advertisement and profile associated therewith, for example, can be input into the system and matching users can be identified without actually providing the advertisement to the user. In this manner, the actual number of users that will receive this ad can be known. An advertiser can further alter an advertisement and a profile and/or settings associated with the advertisement and retest the advertisement. A cycle of advertisement modification and testing can continue until an advertiser is satisfied.

The advertisement component 140 can also include an advertiser suggestion component 140 that, among other things, provides suggestions or recommendations to an advertiser with respect to advertisement creation. The advertiser suggestion component 520 can analyze a plurality of data (e.g., profiles, preferences . . . ) stored with respect to numerous consumers and identifies where no match is being made. Stated differently, the component 520 can identify where there is a need or desire that is not being met. Once identified, the advertiser can be notified via suggestion or recommendation. In particular, the advertiser can be informed that if a particular advertisement is pushed out, it will reach a specific number of potential consumers. It is an advertisement or offer that the advertiser is not contemplating but of which a high push, conversion, and/or redemption rate can be guaranteed. Furthermore, if sufficient information is provided, the advertiser suggestion component 520 can automatically generate an advertisement, promotional offer of the like for presentation to the advertiser. Upon permission, the advertisement can be activated and pushed to potential consumers. Further yet, the advertiser can simply authorize pushing automatically generated advertisements to users within particular parameters (e.g., discount amount, product category . . . without additional confirmation.

Quantified value component 530 is also part of the advertisement component 140 to further aid provisioning of information to advertisers. In particular, the quantified value component 530 can analyze collected market data and provide quantified values for example in reports. The subject marketing support system seeks to receive, retrieve or otherwise obtain or acquire a substantial amount of information to aid in precisely tailoring advertisements to users as well as improving target advertising campaigns. In one instance, an advertiser can subscribe to a service from which reports can be generated and provided thereto to help them understand the current state of a market including perhaps the effectiveness and/or ineffectiveness of other advertiser's advertisement campaigns. Information can also be aggregated and presented to a user in a variety of manners to facilitate comprehension. Still further yet, the quantified value component 530 can answer specific advertiser questions as a function of collected data. For example, a question can pertain to the number of women over 35 in a particular area that have been responsive to offers for discounted salon products, and the quantified value component 530 can provide a numerical response to this query.

In accordance with one embodiment the quantified value component 530 can produce a market assessment designed to form a snapshot of a target market in terms of demographics (e.g., age, gender, income . . . ), psychographics (e.g., hobbies, interests, wants, needs, fears, aspirations . . . ) and behaviors (e.g., where they shop, when they shop, how often they go out, when they want to receive offers, how much money they spend . . . ). Once such information has been collected, advertisers have ample data to estimate response and return on investment of a potential advertisement.

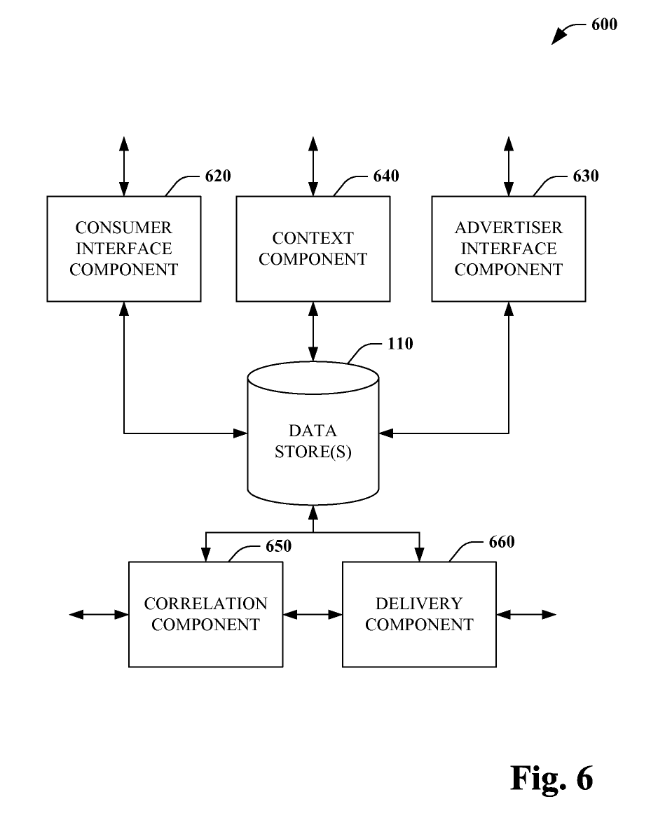

Turning attention now to FIG. 6, a mobile marketing system 600 within which aspects of the support system 100 of FIG. 1 can be employed in accordance with an aspect of the claimed subject matter. The system 600 includes one or more data stores 110 that house data pertaining to at least advertisers and consumers. The number, type, and configuration of data stores can vary. For example, the data store(s) 110 can be embodied as one or more database and data warehouse systems. Consumer interface component 620, advertiser interface 630, and context component 640 are communicatively coupled to the data store(s) 110 and provision different types of data for storage and subsequent employment to facilitate correlation and delivery of advertisements.

The consumer interface component 620 is a mechanism that facilitates collection of consumer or system user information. The extent of such information can vary but in general concerns at least identification of a user and a means for receiving advertisements. For example, a consumer can provide his/her name and specify a mobile computing device such as a mobile phone to receive advertisements. The consumer interface can also collect profile and/or preference information. A profile can include among other things, address, date of birth, gender, profession, income, ethnicity, religion, and/or group memberships. User preferences or settings can include, without limitation, categories of products/services of interest, companies of interest, keywords, advertisement delivery schedule (e.g., days of week, time of day . . . ), and means of notification and/or delivery (e.g., text message, email, local application . . . ). Alone or in combination, the user profile and/or preferences can act as advertisement filters for matching advertisements, as will be described further infra.

The advertiser interface component 630 is a mechanism that aids retrieval of advertiser related information such as advertiser or company, and advertisement or advertisement campaign information, among other things. For example, information can be collected regarding the location and/or particular stores for which advertisements or more specifically promotional offers will be valid. Further, advertisement interface component 630 can facilitate construction of a promotion and specification or particular preferences to control distribution such as category, keywords, and age range. Specifics regarding the promotion can also be acquired including when the advertisement will be sent and the total number of advertisements to be sent or variations thereof (e.g., impressions, views, activations . . . ). Such information can also be referred to as an advertisement or offer profile.

The context component 640 acquires and contributes context information to the data store(s) 110. Context relates generally to conditions that occur surrounding a consumer and/or advertiser, among other things. As will be discussed, further below, context can include, without limitation, user location information, and other extrinsic data. As will further be appreciated in light of later discussion, context provides yet another factor that can be considered when determining whether or not to provide a particular advertisement to a user.

The system 600 also includes correlation component 650 communicatively coupled to the data store(s) 110. The correlation component 650 can acquire data/information at least from the data store(s) 110 for use in correlating or matching advertisements to particular users. Matching can range from relatively simple to quite complex. For example, matching can be accomplished by determining whether or not a consumer and advertiser filters match. Additionally or alternatively, the correlation component 650 can engage in a more predictive assessment, for instance, where it infers matches as a function of a collection of information for which filters or preferences have not be explicitly identified. In one particular embodiment, the correlation component 650 can make predictions based on community likeness or affinity groups in which a user is deemed a member.

Delivery component 660 is communicatively coupled to the correlation component 650 as well as the data store(s) 110. Upon receipt or retrieval of matching advertisements from the correlation component 650, the delivery component 660 can deliver the advertisement or advertisement related information to a user by way of some computing device associated with the user. By way of example and not limitation, the delivery component 660 can send a text message (e.g., Short Message Service (SMS) communication), multimedia message (Multimedia Messaging Service (MMS) communication), e-mail (electronic mail), or an application message including the advertisement and/or information pertaining to the advertisement.

Further, the delivery component 660 can utilize information from the data store(s) 110 to determine if, when, and/or to which device the advertisement is sent. For example, a user may set preferences that dictate delivery. Additionally or alternatively, the delivery component 660 can determine or infer delivery specifics based on context information. For instance, if it can be determined that a user is likely skiing down a slope based on temperature, weather conditions, altimeter, and accelerometer data, the delivery component 660 would probably wait to transmit the advertisement until he/she is in line at a lift or in lodge café. Furthermore, where a user employs more than one device capable of receiving advertisements the delivery component 660 can also determine or infer to which device a user would prefer to receive an advertisement and send it to that device.

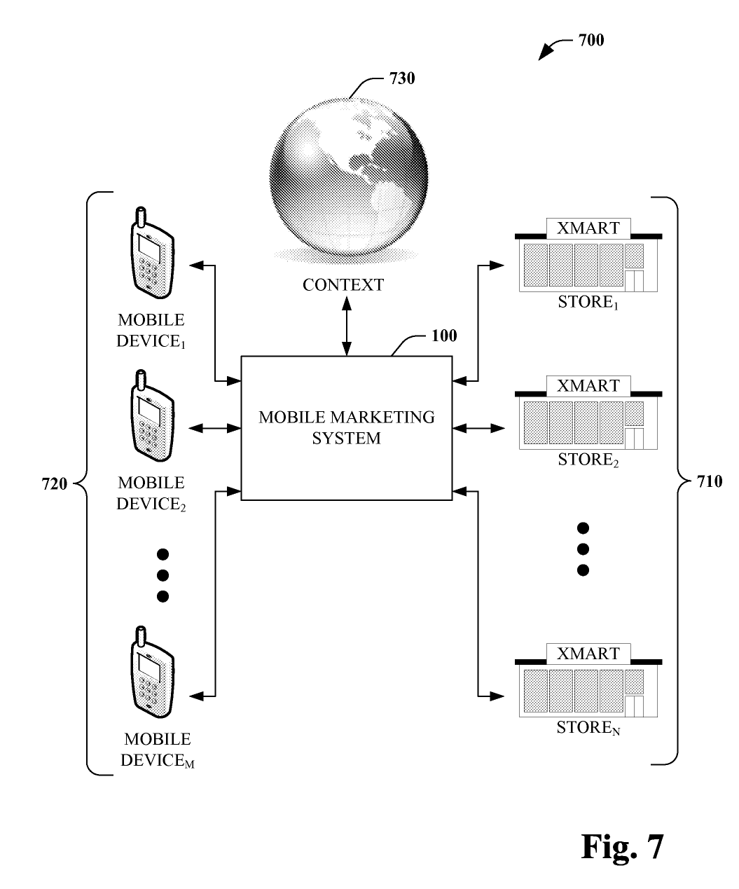

FIG. 7 depicts an exemplary environment 700 in which the mobile marketing system 100 can be utilized. In particular, the mobile marketing system 100 is positioned between a plurality of merchants or stores 710 (STORE₁-STORE_{N}, where N is greater than or equal to one) and mobile devices 720 (MOBILE DEVICE₁-MOBILE DEVICE_{M}, where M is greater than or equal to one). The stores 710 can be traditional physical stores and/or online stores. Further, it should be noted that one or more stores 710 could correspond to the same store yet in a different location such as the case in chain or franchise stores. The mobile devices 720 can correspond to any computing device that is able to receive an advertisement. For example, a mobile device can be embodied as a mobile phone, a palmtop computer, a personal digital assistant (PDA), a music player, a GPS receiver, or an electronic book reader, among other things. Where a device cannot acquire such a message directly over some communication framework (e.g., cellular phone, Internet . . . ), it can be afforded indirectly by way of some other device (e.g., Bluetooth, wired connection . . . ). Furthermore, it should be noted that although described as mobile, such device 720 is not so limited and as such can also be substantially immobile. In addition to information provided by stores 710 and mobile devices 720, the mobile marketing system 100 can also acquire contextual information or context 730 from some other device (e.g., car, appliance . . . ), place, location, or supplier.

The environment 700 is provided to facilitate clarity and understanding with respect to aspects of the claimed subject matter. As shown, the mobile marketing system 100 is positioned between the stores 710 and mobile devices 720. This position is conceptually significant. In one embodiment, the mobile marketing system can be employed by one store and one or more devices 720. In this situation, the mobile marketing system 100 has access to a plurality of users and information regarding their interaction with the sole store 710. However, where multiple stores 210 are employed in conjunction with multiple mobile devices 720, the mobile marketing system 100 acquires information about numerous users and their interactions with a plethora of stores. In this scenario, this information gain is beneficial to both users and stores. For example, information about advertisements provided to and/or offers redeemed by users from multiple stores can be utilized to further refine correlation to provide more users with more relevant advertisements advertisers with more effective campaigns. Further, such information can be fed back to advertisers to allow them to readjust or retarget advertisement campaigns,

More specifically, a consumer's mobile device 720 can be electronically linked to a mobile marketing system database. This link, over time, can provide discrete snapshots of transactional interaction data that illustrate how the consumer responds to an advertisement. Advertisement details such as specific product or service, type and size of discount, how quickly an offer is activated, where the consumer was traveling and other significant time-location based aspects can be collected. A consumer's experience can be associated with the transactional interaction data producing a three hundred and sixty degree view of the consumer's behavior. Still further yet, each consumer's transactional interaction data or transactional exhaust can be leveraged to aid target advertisement generation and advertisement correlation, for example based on affinity groups or the like.

It is to be appreciated that while the mobile marketing system 100 can reside between stores 710 and devices 720, implementations of the system need not provide such distinct separation. By way of example and not limitation, at least a portion of the mobile marketing system functionality can be resident on mobile devices 720. For instance, a mobile device 720 can include an application executed thereon that communicates with an external server as needed. The functional split can also be adjusted as a function of capabilities (e.g., dumb vs. smart device) and substantially in real-time based on device and/or server load or failure, among other things.

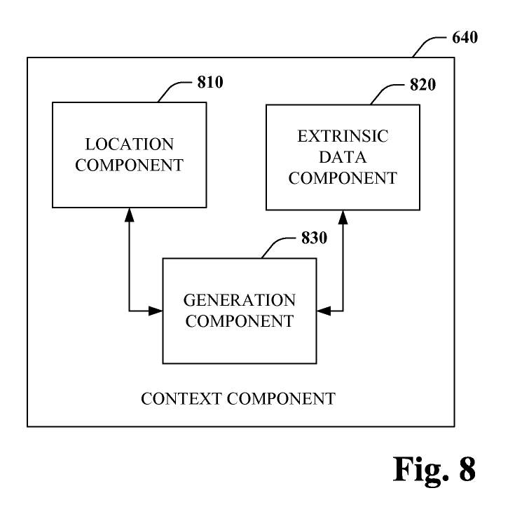

Turning attention to FIG. 8, a representative context component 640 is illustrated in accordance with an aspect of the claimed subject matter. As previously mentioned, the context component 640 facilitates collection of information regarding conditions surrounding a consumer and/or advertiser, among other things. One such piece of information is user and advertiser location, which can be acquired by location component 810. Location can be obtained in a variety of manners. For example, the location component 810 can collect this information from a user (e.g., city, state, zip code . . . ). Additionally or alternatively, location information can be acquired from a mobile computing device. For example, a device GPS receiver and/or wireless communication (e.g., cellular triangulation, IP address location . . . ) can be employed to identify location of which location component 810 can receive or retrieve. The location component 810 can also acquire location information from third party services and/or devices (e.g., mobile GPS, car navigation system . . . ). Other options are also available including the use of RFID (Radio Frequency Identification) tags, proximity sensors, or geo-fencing. For instance, location can be determined when a user moves within a set distance of a proximity sensor or into or out of a geo-fence. While location can determined at a single point in time, it is also to be appreciated that it can be acquired in substantially real-time to enable a user's movement to be tracked, for example. Furthermore, the location component 810 can collect location from multiple suppliers and determine location based on aggregated information.

Moreover, context can include more than simple consumer and advertiser location. In particular, extrinsic data component 820 can receive, retrieve, or otherwise obtain or acquire additional data or information that is useful in advertisement correlation. As used herein, extrinsic data excludes location or explicitly specified profile or preference information, unless otherwise clearly stated. Extrinsic data, however, does include at least that which is outside control of either a consumer or advertiser. Examples of such data include, without limitation, time, temperature, weather, altitude, barometric pressure, time of day, and day of week. Furthermore, extrinsic data can also refer to data or information that is extrinsic to the advertiser while it may be at least to a degree intrinsic to or within control of the consumer. For instance, consider a consumer's proximity to other consumers or velocity. The extrinsic data component 820 can acquire this information in a variety of different ways including via sensors (e.g., user device, external, environmental, proximity . . . ) and third party services, among others. For example, temperature can be determined from a thermometer associated with a mobile device or from a weather service.

Context component 640 can also optionally include a generation component 830 that can produce additional context data based at least upon information from location component 810 and/or extrinsic data component 820. More specifically, the generation component 830 can utilize deductive reasoning, and/or inferences, among other things, to produce higher-level context information from lower-level pieces of context information and/or missing or unavailable information. For example, even if temperature is not known, other information such as altitude, location, season, and month, among other things can be utilized to estimate a temperature.

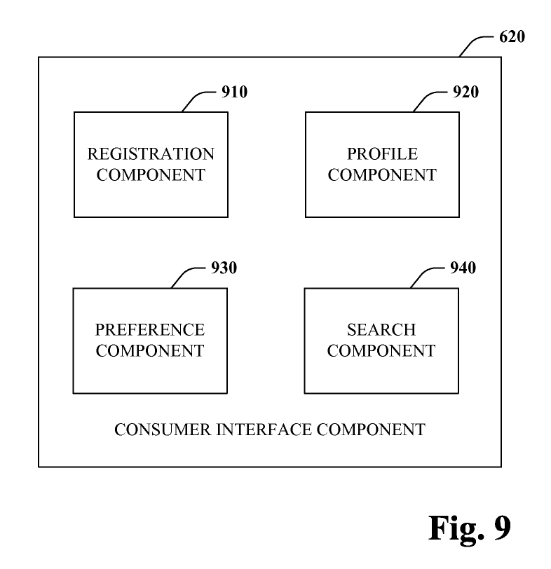

Referring to FIG. 9, a representative consumer interface component 620 is illustrated in accordance with an aspect of the claimed subject matter. The consumer component 620 provides a mechanism for a user or consumer to input data and interact with a mobile marketing system. As shown, the consumer component 620 includes a registration component 910, profile component 920, preference component 930, and search component 940.

The registration component 910 enables a user to register with a mobile marketing system and thereby make them eligible to receive advertisements. For example, the registration component 910 can afford one more graphical user interfaces or wizards to prompt users to enter such information as name, address, phone number, email or the like. A user account can subsequently be created after user information is validated, for instance by sending an email which includes an activation link.

The profile component 920 provides a mechanism for capturing user information about a user or a profile. For example, profile information can include similar things requested during registration as well as other information such as but not limited to birth date, gender, marital status, ethnicity, religion, group affiliations, profession, home ownership status, or other demographic information. Various other information can be entered that aid in defining and/or describing a user. Of course, none of this information is strictly necessary, but any profile information added can later be employed to facilitate location of relevant advertisements.

The preference component 930 facilitates input and receipt of user advertisement preferences or settings. By way of example and not limitation, a user can select categories and subcategories of goods and services of interest, and input keywords and brand/merchant preferences. Other settings can also include size of offers, maximum bid, frequency, privacy settings, temporary settings such as travel, vacation, expiration, and work, and a professional setting. Furthermore, a user can utilize the preference component 930 to specify delivery times and means of delivery and/or notification (e.g., email, SMS, MMS . . . ).

The search component 940 provides a mechanism to search for or otherwise locate advertisements of interest. More specifically, the search component 940 accepts advertisement queries in various forms and returns matching results. In other words, rather than sitting back and waiting for advertisements to be provided to them, users can proactively attempt to locate and acquire advertisements of interest.

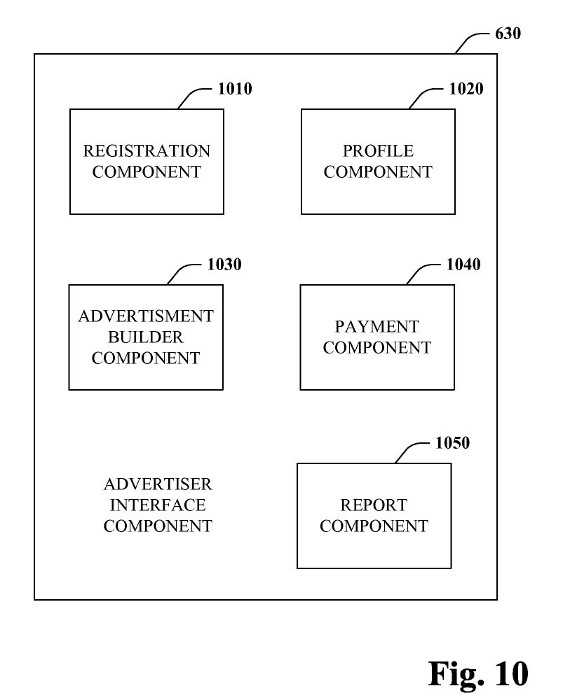

FIG. 10 depicts a representative advertiser interface component 630 in accordance with an aspect of the claimed subject matter. Similar to the consumer component 620, the advertiser component 630 includes a registration component 1010 and a profile component 1020. The registration component 1010 is a mechanism for registering an advertiser or creating an advertiser account. Information can be input utilizing one or more interfaces. Registration information can include, among other things, company name, federal tax id, address, phone, number contact person, and email. After such information is provided and validated via one or more mechanisms (e.g., e-mail activation, challenge response test . . . ), profile information can be entered in a like manner. In addition to registration information, profile information can include business structure information and the identification of additional store information (e.g., chain stores, franchises) and/or information about a particular advertisement or campaign.

The advertiser component 630 also includes an advertisement builder component 1030. As the name suggests, the advertisement builder component 1030 facilities construction of advertisements and/or advertising campaigns. Although not limited thereto, in accordance with one embodiment a series of graphical user interfaces can be presented to an advertiser that guides him/her through such a process. It should be appreciated that preferences or settings can be associated with advertisements at this point including such things as categories, subcategories, keywords, gender, age range, interests, and hobbies, among other things. Further yet, such settings can relate to advertisement and/or campaign validity including but not limited to validity dates (e.g., start date and end date), number of times a user can receive an advertisement, delivery schedule and maximum number of impressions. Together the preferences and settings relating to an advertisement can comprise an advertisement profile.

An advertisement generated by builder component 1030 can take any form that draws attention to or promotes some product or service. Accordingly, the advertisement can simply identify a product via image, audio, video, and/or scent for instance. However, advertisements that are more complex are contemplated including, without limitation, promotions, and/or use of coupons. Furthermore, presentation can differ. In one embodiment, promotional coupons can be produced that include either a promotional alphanumeric code or bar code, for instance. Further, the entire coupon including the promotional code need not be sent initially. For instance, a consumer can be notified of such a coupon first with a description of the product and/or service offer. This can be termed and offer impression. Subsequently, if interested, the consumer request more details including the coupon and promotional code. In other words, the coupon can be activated. Such a request or activation can correspond to clicking on the notification to initiate download of the coupon, texting a message “GET,” sending an e-mail, or placing a call, inter alia. Further, it is to be noted that the advertisement can include or be associated with a host of other information to aid consumers including such things as an advertiser's address and phone number, a map to one or more locations and a link to the advertiser's website, for example. Still further yet, while promotional code can aid in tracking offer usage (e.g., impression, activation, impression), a unique tracking code can also be associated therewith for that purpose.

Payment component 1040 is a mechanism to enable billing or invoice generation and receipt of payment from advertisers. Similar to other advertiser components, various interfaces, graphical or otherwise, among other things, can be employed to provide such functionality. Variations are likely since a multitude of different payment agreements and/or arrangements can be employed. In accordance with one embodiment, an advertiser can be afforded an invoice generated as a function of impressions, activations, and redemptions. Impressions refer to notifications of offers. Request and receipt of the actual offer are activations, and redemptions refer to purchases made that take advantage of an offer. Additionally or alternatively, payment component 1040 can include or be associated with a separate component (not shown) to provide auction functionality to advertisers, for example to bid against each other for the right to afford a user an advertisement in a particular context. It is also to be noted that a user can provide the payment component 1040 with a budget associated with the number of impressions, activations, and/or redemptions in an attempt to cap cost.

Report component 1050 provides information about the performance of an advertisement campaign to an advertiser. For example, number of impressions, activations, and redemptions related to a promotion can be provided. Further, additional information or characteristics of particular consumers can be afforded including those that (1) received an offer but did not activate it, (2) received the offer and activated the offer but did not redeem it, and (3) received the offer, activated the offer, and redeemed the offer. Overall, such information aids advertiser in determining advertisement effectiveness and enables subsequent campaigns to be improved.

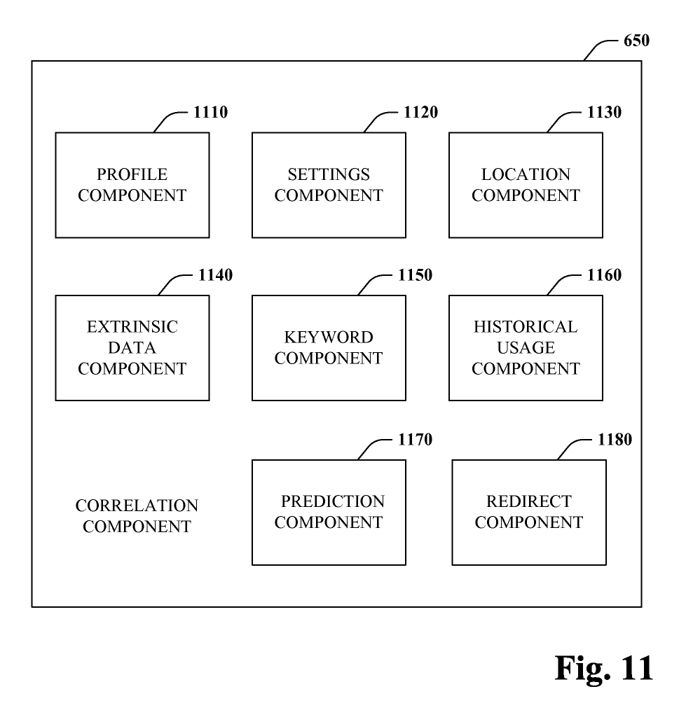

FIG. 11 depicts a representative correlation component 650 in accordance with an aspect of the claimed subject matter. Recall that generally correlation component 650 correlates or matches advertisements to consumers. Matching can be performed in a variety of different ways as a function of a host of different data. Representative correlation component 650 and following description thereof is an attempt to clarify a few ways in which correlation can be performed. Of course, the claimed subject matter is not limited thereto.

Components 1110, 1120, 1130, and 1140 pertain to performing correlation with respect to particular kinds of context information. In particular, profile component 1110 enables matching of advertisements based on consumer profile information. For instance, this can include a consumer's age, gender, marital status, profession, ethnicity, and/or religion, amongst other information. Settings component 1120 allows correlations based on consumer and/or advertising settings. Consumer setting information can include at least categories and subcategories of interest, preferred retailer, and designated time for receiving offers. Advertiser settings can specify characteristics relating to a preferred recipient including, among other things, age, gender, and interests/hobbies as well as campaign categories and subcategories, geographic limits, and keywords for example. Location component 1130 enables matching based on at least consumer location. Extrinsic data component 1140 allows correlation as a function of extrinsic data including without limitation temperature, weather, barometric pressure, altitude, time of day, day of week and/or season. While the correlation component 650 can match based on each of these pieces of contextual information separately, it can also match as a function of all or combinations of such information.

Keyword component 1150 enables correlation as a function of keywords. In one instance, keywords can form part of user and or advertiser settings and matched in that situation. Additionally or alternatively, the correlation component 650 can be employed to directly search for advertisements of interest. In that case, the correlation component 650 can match based at least upon query key words.

Historical usage component 1160 allows the correlation component to match advertisements as a function of historical advertisement usage. In other words, previously received, activated and/or redeemed advertisements or offers can form a basis for future matching. For example, if a user previously redeemed an advertiser's promotional offer, the same or similar offers can be subsequently matched with higher relevance. Furthermore, it is to be appreciated that historical advertisement usage can be employed with respect to not only a single advertiser and consumer but also across all advertisers as well as all consumers or subsets thereof.

Prediction component 1170 enables the correlation component 650 to make predictions or inferences related to advertisements that may be of interest. In one embodiment, affinity groups can be employed as basis for prediction. For example, utilizing various industry models, spectral clustering, and/or micro-segments users can be determined or otherwise classified as members of one or more affinity groups. Subsequently, predictions can be made for specific consumers as a function of group wants, needs, or desires. Furthermore, predictions can be made as a function of one or more models including industry standard models as well as learned or otherwise acquired behavioral models. By way of example, it is known that if a man purchases diapers at a grocery store he will also likely purchase beer. Accordingly, if it can be determined that such a consumer has purchased or is in the process of purchasing diapers an advertisement for beer can be provided. In another instance, it can be determined that a certain path is followed through a mall or other group of proximate stores such a behavioral model can be utilized to ensure that advertisements are afforded to consumers for retailers on that path as the consumer moves.

Redirect component 1180 provides correlation based on competition. When specified, consumers can be directed away from a first advertiser and to a second advertiser by matching advertisements for the second advertiser when otherwise advertisements for the first advertiser are or would be matched. In other words, consumers are redirected to another advertiser. For example, when a consumer is located within a predetermined proximity of a coffee shop A, then an advertisement for coffee shop B can be matched and delivered.

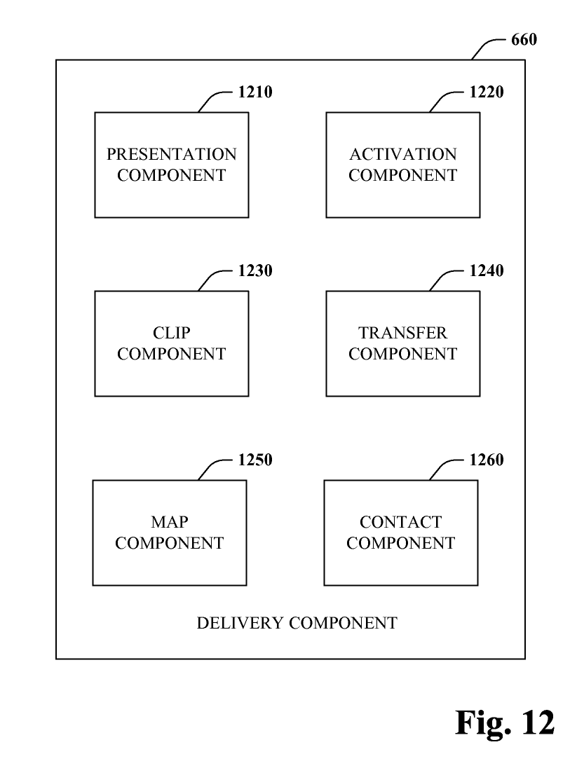

FIG. 12 depicts a representative delivery component 660 in accordance with an aspect of the claimed subject matter. The delivery component 620 includes a presentation component 1210 that provides an advertisement or information about an advertisement to a user. The actual mechanism employed by the presentation component 1210 varies based on preferences/settings and device capability, among other things. For example, an advertisement can be delivered by text message (SMS), multimedia message (MMS), e-mail, or through an application. One or more distribution mechanisms can be employed by the presentation component 1210 to provision advertisements to consumers. For example, information about a promotional offer can be provided to a user via text message as well as e-mail. Moreover, context can be accounted for in determining the best means of notification.

Activation component 1220 enables an advertisement to be activated. As previously described, rather than providing a full advertisement or offer to a consumer upon matching, the consumer can simply be notified of the advertisement. Subsequently, if desired, the advertisement or offer can be requested and acquired. In such a scenario, the presentation component 1210 described above can provide the notification functionality. Activation component 1230 receives a request for a particular advertisement that the consumer was notified of and activates or provides the advertisement to the requesting consumer. The request portion of activation can be performed utilizing different means or mechanisms, which can be dependent upon the notification means. For example, where a consumer is notified of an advertisement by text message, then the consumer might request the advertisement by texting “GET” or the like in a reply to the notification. Alternatively, activation can require calling a particular phone number or e-mailing a specific address, among other things. Once requested the actual advertisement or offer can be provided to the user by the activation component 1220 via the same or a different communication medium.

Clip component 1230 is a mechanism for saving an advertisement. Similar to physically clipping or cutting out a coupon, clip component 1230 can save an advertisement or coupon for later viewing, redemption, among other things. By way of example, once a user receives a promotional offer, after activation or otherwise, an option can be provided to clip the offer. If selected, the clipping can be noted by the clip component 1230, and recorded, stored or the like in any manner that enables later retrieval by the consumer.

Transfer component 1240 provides functionality for transferring an advertisement to another consumer. If a consumer acquires an advertisement, offer or the like that he/she believes another person (e.g., friend, family member, colleague . . . ) would desire, it can be transferred to the person utilizing the transfer component 1240. Of course, the means of transfer can vary by capabilities of the sending device and receiving device as well preferences or settings wherein the receiving person is a subscriber, user, member, or the like of the subject advertising system. Transfers to nonsubscribers, nonmembers or the like can be implemented to require subscribing to the advertising service or not.

The delivery component 660 can also include or be associated with a map component 1250 and a contact component 1260 both of which provide added value to advertisement provisioning. The map component 1250 aids a consumer in navigating to a source of the advertisement or offer redemption location. In furtherance thereof, the map component 1250 can provide directions including a map, among other things. The contact component 1260 provides information to facilitate contacting an advertising source such as a retailer. Such information can include an address if not provided by the map component 1250 as well as a phone number and optionally a website if available. In one embodiment, where the retailer operates an online store, the contact component 1260 can direct the user to the store to redeem a promotional offer, for example.

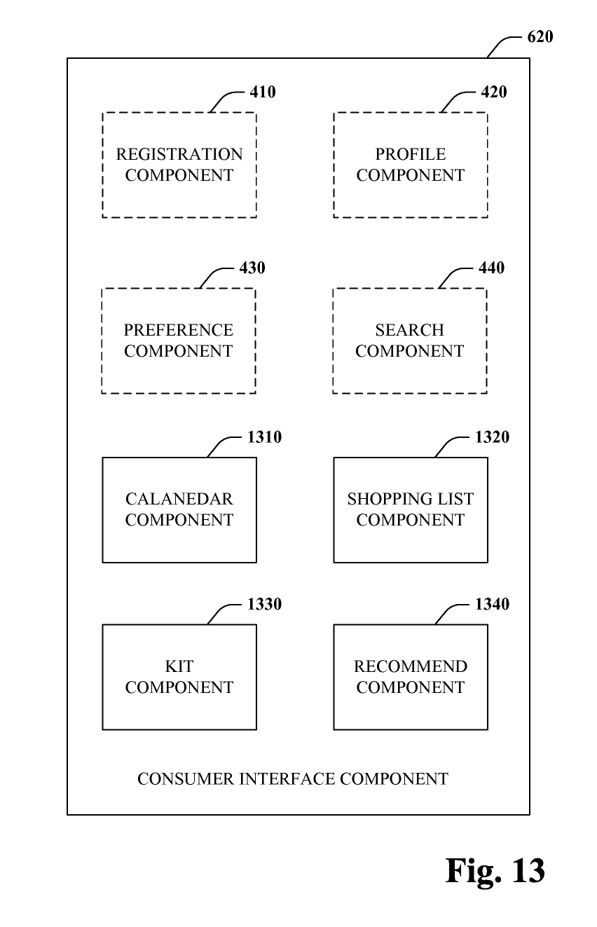

Referring to FIG. 13, a representative consumer component 620 is illustrated in accordance with an aspect of the claimed subject matter. Similar to the consumer component presented in FIG. 9, consumer component 620 includes the registration component 910, profile component 920, preference component 930, and search component 940, as previously described. Among other things, these components aid consumer interaction with a marketing system. The consumer component 620 can also include additional functionality for assisting in acquiring information, as well as providing information.

In particular, the consumer component 620 can include a calendar component 1310 that can facilitate specification and/or acquisition of consumer preferences or other event relevant information. In one embodiment, the calendar component 1310 provides a mechanism to associated preferences or filters and/or categories with particular dates including purchase events. For example, a consumer can add some categories and/or filters to a date associated with a relative's birthday. On or before that date, these filters and categories can be automatically activated. As a result, advertisements will be sent that are tailored to that event. Moreover, users need not specify particular filters but rather can simply identify particular products or services and the calendar component 1310 can automatically generates appropriate filters. Additionally or alternatively, items can be shared with others. For example, one consumer can set up a wish list or the like for events (e.g., birthday, Christmas . . . and share them with other users. Upon copying or otherwise receiving this list, the calendar can generate filters automatically and associated them with the particular event date.

Consumer component 620 can also include a shopping list component 1320 that focuses advertisement matching with respect to a particular shopping list. In one embodiment, the shopping list component can aid generation of such a list. Additionally or alternatively, a list can be otherwise acquired such as by upload, download, import or the like. Once acquired, the shopping list can be utilized to adjust categories, filters or the like that influence matching. In one implementation, adjustments based on the shopping list can override at least temporarily other setting since shopping interests are known.

Kit component 1330 enables acquisition of information about kits and employment of the information in modifying categories, filters or the like based thereon. Kits are sets of items employed for a particular purpose. Recipe kits are one example. However, kits can be much more general. For instance, a set of computer equipment including a laptop, mouse, and bag, among other peripherals can be a kit. Upon acquiring information about a desired kit, kit component 1330 identifies kit items and sets filters or the like to facilitate provisioning of promotional offers for the items to enable purchase of the kit at a low cost. It should be noted that a retailer could prepackage all kit items in an attempt to attracted such buyers and offer a discount on the collection of items. Accordingly, a promotional offer associated therewith can be sent to a potential consumer.

The consumer component 620 can also include a recommend component 1340. The subject system is not limited to providing advertisements. In addition or as an alternative, collected information can be utilized to provide retailer advertiser independent recommendations. The same or similar categories, filters, contextual information and the like that are utilized to match advertisements can be employed to simply make suggestions or simply provide valuable information. For example, if a consumer likes pizza for lunch, at lunchtime all local pizza shops can be provided to the user. In another scenario, in a meeting where a salesperson is attempting to land an important client and client representative filters, shopping lists or the like are available, the salesperson can be informed before the meeting that the chief executive officer of the potential client company likes seventeen-year-old scotch.

According to one aspect of claimed subject matter advertisements including promotional offers, coupons and the like can be provided to a user for subsequent redemption at a store. For example, as previously described, an alphanumeric or bar code style promotional code can be provided to a mobile device that can be shown input, shown, scanned or the like at a point of sale. However, claimed subject matter is not so limited in the distribution of promotional offers. In accordance with one embodiment, discounts can be provided to and saved onto loyalty cards or the like. For example, rather than or in addition to providing a promotional offer for a grocery store product to a user via an associated mobile device, the offer can be provided to and saved with respect to the grocery store loyalty card. Accordingly, the discount can be automatically taken on the product upon presentation of the loyalty card. Moreover, the coupon can be provided to multiple loyalty cards for use at more than one store and/or removed after redemption.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the dialog component(s) 120, advertisement component 140, and analysis component 130 can all employ such mechanism to facilitate intelligent dialog, analysis, and advertisement generation, among other things. It is also to be appreciated that correlation component 650 and delivery component 660 can employ these mechanisms to infer advertisement matches and when and how to deliver matching advertisements.

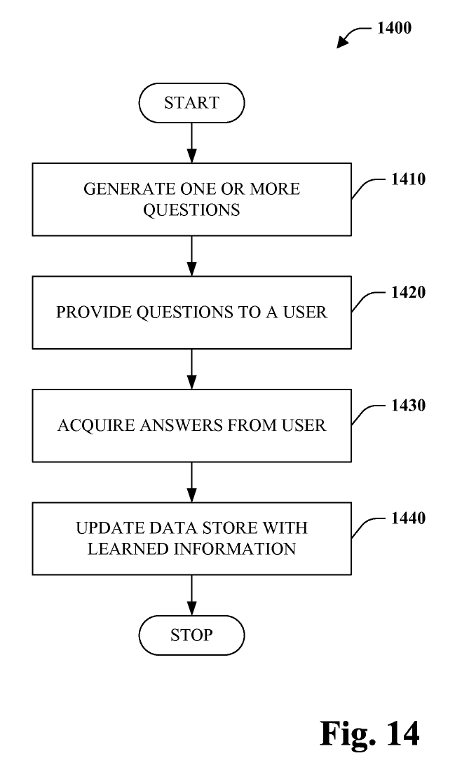

In view of the exemplary systems described supra, methodologies that may be implemented in accordance with the disclosed subject matter will be better appreciated with reference to the flow charts of FIGS. 14-26. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 14, a method of actively collecting information from a user 1400 is illustrated in accordance with an aspect of the claimed subject matter. At reference numeral 1410, one or more questions can be generated that are designed to elicit information about a user's preferences, opinions, attitudes, or the like. While such questions can be general questions, it is also to be noted that the questions can be tailored for particular users, for example based current knowledge, previous answers to questions, and/or context information, among other things. By way of example, if it is determined that a user is employing a mobile phone the number of questions provided may be smaller than if the user is utilizing a desktop or other more powerful computer. At numeral 1420, the one or more questions are provided to a user. Again, the manner in which questions are provided can be context dependent. By way of example and not limitation, mobile phone destined questions can be provided in a manner that requires a single response such as a rating from 1-10 or a sliding of a rating bar from one side to another, while desktop questions can employ more open ended questions in a survey format. At reference 1430, answers or responses to the one or more questions are acquired from a use. Subsequently, a data store can be updated with this learned information.

In sum, the method 1400 provides means for teaching a marketing system about a user by engaging the user in a dialog with the system. In accordance with one embodiment, dialog can occur when a user is online and employing a desktop, laptop, or other computer device. Additionally or alternatively, the dialog can be performed with respect to a mobile phone device as a user interacts in the world. Furthermore, it should be appreciated that while dialog can textual in nature it is not limited thereto. Audio and/or video can also be utilized, among other things. For example, speech recognition technology can be employed to allow a user to speak responses to questions.

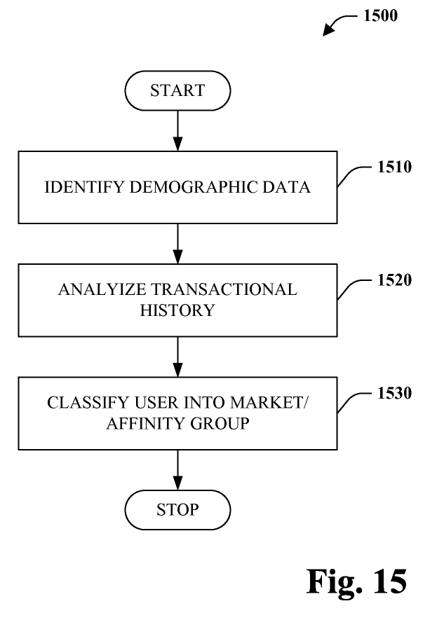

FIG. 15 illustrates a method of data analysis 1500 in accordance with an aspect of the claimed subject matter. At reference numeral 1510, demographic data associated with a user, member or consumer can be identified. Such information can correspond to profile and/or preference information entered by a user, dialog information, and/or information obtained from a third party. At numeral 1520, transactional history is identified and analyzed. The transactional history can correspond to offers viewed, activated, and/or redeemed, among other things. At reference numeral 1530, the user can be classified into one or more market segments or affinity groups as a function of at least demographic and transactional data.

Classification can aid predictive correlation since a user's needs or desires can be linked to one or more groups, for example. Furthermore, a change in groups can allow needs or desires to be attributed to a user even though the user may not yet be aware thereof. For instance, a move from single to married or from married to married with children cause different advertisements to be matched and delivered. In particular, upon birth of a child a user may be moved to such an affinity group and provided with advertisements for the latest most popular infant toy that the user was previously unknown to the user. Of course, it should be appreciated that such groups can be much more specific or granular (e.g., micro segment).

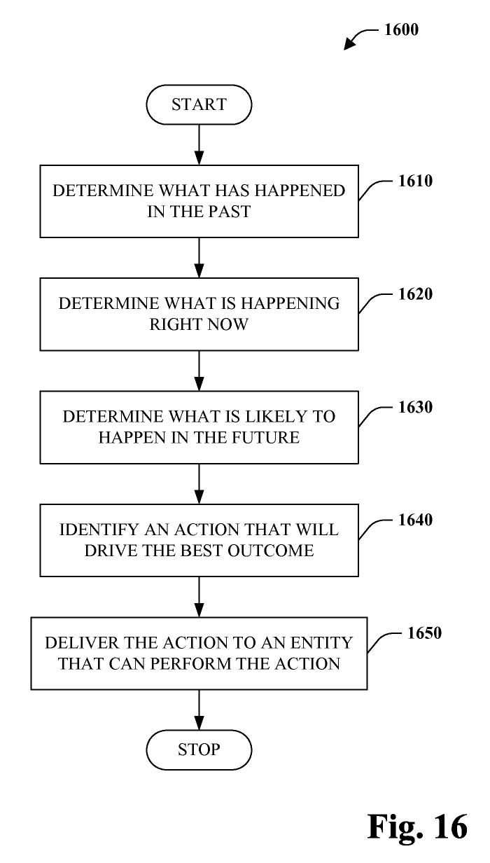

FIG. 16 illustrates a method of data analysis 1600 in accordance with an aspect of the claimed subject matter. At reference 1610, a determination is made as to what has happened in the past. At 1620, a determination is made as to what is happening currently, and at 1630, a determination is made as to what is likely to occur in the future. These determinations can be made at least in part based on current and previously recorded data house in one or more data store, for instance. Furthermore, various statistical, mathematical, and or other algorithmic techniques can be employed with respect to making these determinations. At reference numeral 1640, an action that will drive the best outcome or in other words an optimal action is identified, determined, or inferred. At numeral 1650, the action is delivered to an entity that can perform that action (e.g., individual, computer, system . . . ).

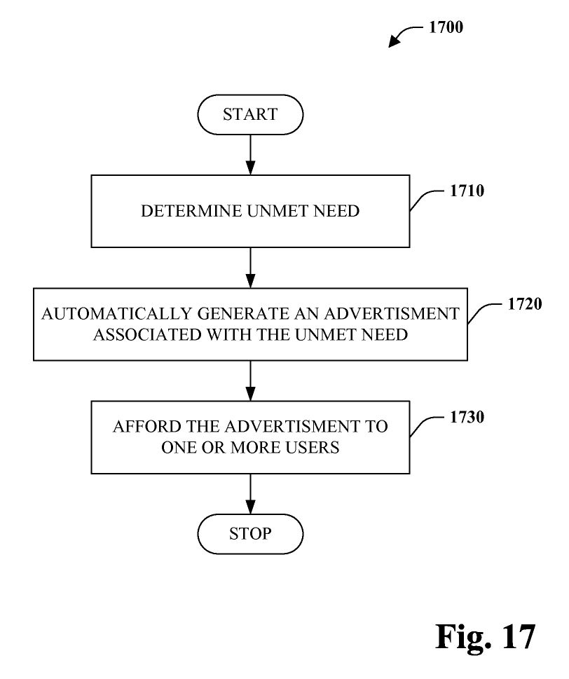

Turning attention to FIG. 17, a method of assisting and advertiser 1700 is illustrated in accordance with an aspect of the claimed subject matter. At reference numeral 1710, an unmet need or desire is determined or otherwise inferred. For instance, the unmet need can be identified based on user information (e.g., profile, preference, dialog . . . ) as well as knowledge of current advertisements, among other things. At 1720, an advertisement can be automatically generated to address the unmet need. Of course, this assumes that an advertiser has provided enough information to enable this automatic generation including such things as graphics, codes, parameters, or the like. This advertisement can then be afforded to one or more users to satisfy their need or desire.

Although not shown, it should be appreciated that an advertiser may need to authorize the generation and/or approve dissemination of the advertisement. At this point, the advertisement could be adjusted prior to affording the advertisement to users (e.g., adjust the discount offer from 20% to 10%). Accordingly, the advertisement can simply be a suggestion. Along those lines, an advertisement need not be generated at all. Rather, the advertiser could simple receive a suggestion or recommendation with respect to a particular advertisement based on an unmet need, for instance, that the advertiser could then use to build an advertisement.

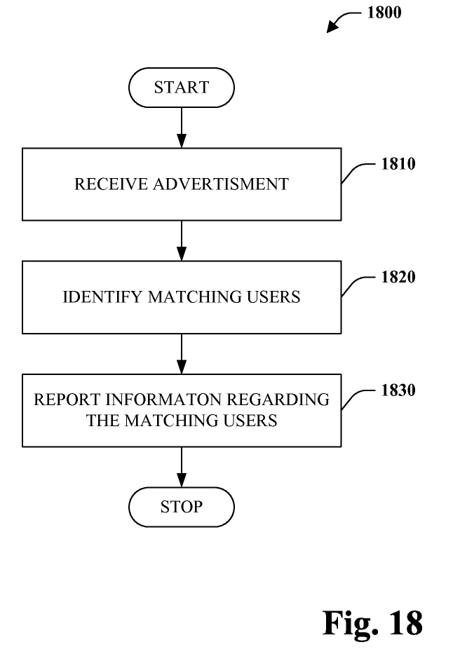

FIG. 18 is a flow chart diagram of a method of concept testing 1800 in accordance with an aspect of the claimed subject matter. At reference numeral 1810, an advertisement is received for testing. Matching users are identified at 1820. In particular, the advertisement can be run through marketing system correlation without delivering the advertisement to users. At reference 1830, information is reported to an advertiser regarding the number of matching users. From this information, the advertiser can choose to modify the advertisement to target additional or fewer users and re-test the modified advertisement. Alternatively, the advertisement can be made live and disseminated to matching users.

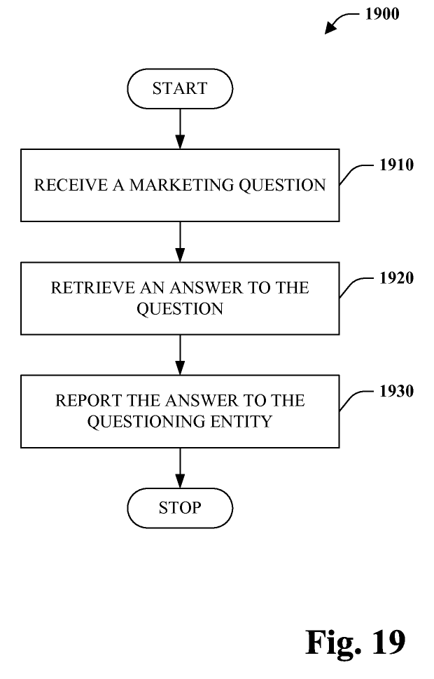

FIG. 19 depicts a method of advertiser inquiry 1900 in accordance with an aspect of the claimed subject matter. At 1910, a marketing question can be received from an advertiser, for example. An answer to the question can be retrieved at 1920. For example, a search can be performed with respect to data collected by a mobile marketing system. At reference numeral 1930, the answer is reported to the questioning entity. In this manner, advertisers or the like can leverage the information collected and/or generated by a mobile marketing system to gain insight into one or more markets for one or more reasons.

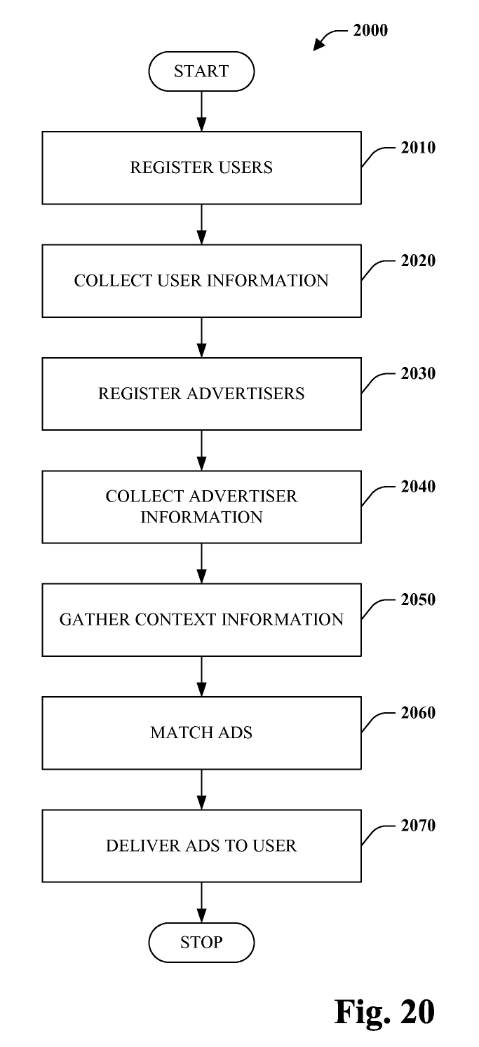

Referring to FIG. 20, a mobile advertisement method 2000 is illustrated in accordance with an aspect of the claimed subject matter. At reference numeral 2010, users or consumers are registered. In other words, users have indicated their desire to receive advertisements and the like by providing basic information. At numeral 2020, user information can be collected. User information can include among other things user profile, preferences and/or settings. For example, a user can indicate that they are a white male age 28 located in Cleveland, Ohio and are interested in casual dining offers delivered weekdays at lunch time. At reference 2030, advertisers are registered. Similar to user registration, advertisers indicate their desire to supply advertisements and the like by providing basic advertiser information. At reference 2040, additional advertiser information is collected including an advertisement or advertising campaign, details, settings such as campaign categories, subcategories, age range, and gender, as well as campaign validity information including start and end dates, maximum impressions, and deliver times. At numeral 2050, context data can be acquired including location and extrinsic data, among other things. At reference numeral 2060, advertisements are matched to consumers as a function of consumer, advertiser, and/or context information. Matched advertisements can subsequently be delivered to users/consumers at numeral 2070.

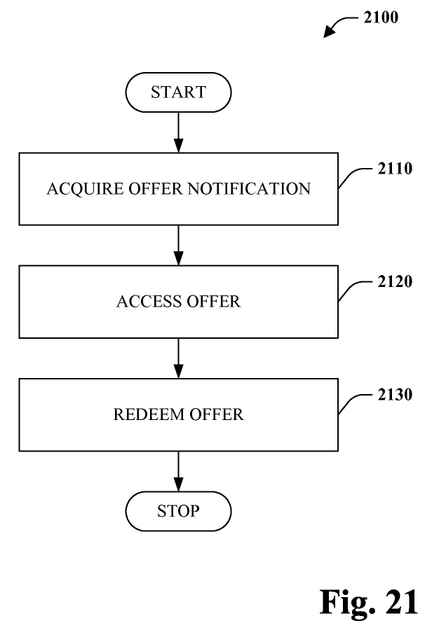

FIG. 21 depicts a method of advertisement employment 2100 in accordance with an aspect of the claimed subject matter. At reference numeral 2110, electronic notification of an offer is provided to a user. For example, such notification can be provided via SMS, MMS, or a local application. In one embodiment, the offer can correspond to products and/or services of interest as determined as a function of one or more of a user profile, user settings, location, and extrinsic data. The notification can provide a brief description of the offer to aid the user in determining whether to further investigate the offer. At numeral 2120, the offer is accessed which includes additional information including a promotional or other unique code (e.g., alphanumeric, bar code), among other things. In one implementation, the offer can be accessed through or with help from the notification. For example, a link can be provided in the notification for navigating to the offer. Alternatively, the notification can facilitate sending a specific text message that will initiate provisioning of the offer. Still further, yet a phone number can be provided in the notification to access the offer. At reference numeral 2130, the offer can be redeemed at a point of sale for purchase of specific products or services. At a physical store, redemption can involve providing the promotional or other code to a user visually, verbally and/or electronically by way of scanning or beaming, for instance. Alternatively, the offer can be redeemed at an online store by entering a particular code or alternatively the code may be automatically entered or provided to the online store.

Note that advertisers can pay or be billed for one or more user action including offer notification (e.g., impression), access (e.g., activation), or redemption. Furthermore, utilizing the promotional code and/or another unique tracking number associated with the advertisement, for example, transactional data regarding impressions, activations, and redemptions can be captured and later employed aid advertisement correlation.

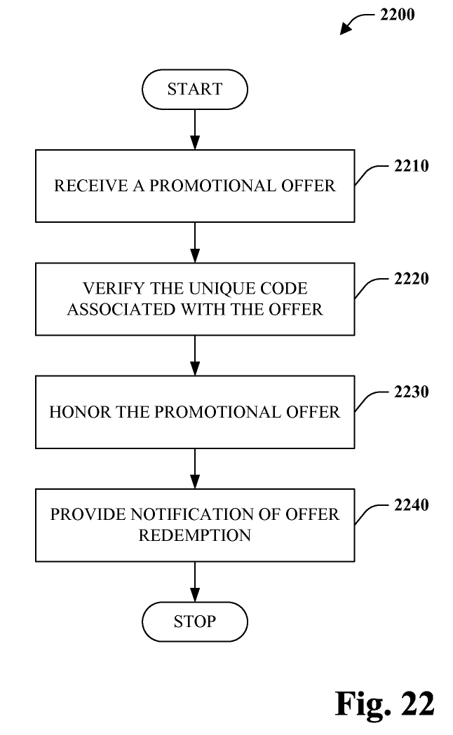

FIG. 22 is flow chart diagram of a method of offer redemption 2200 in accordance with an aspect of the claimed subject matter. At reference numeral 2210, a promotional offer or promotional offer coupon is received. For example, at the point of sale a user can provide a promotional and/or unique tracking code (e.g., numeric, alphanumeric, bar code . . . ) verbally, visually, and/or electronically (e.g., scanner, Wi-Fi, Bluetooth . . . ). At numeral 2220, the unique code is verified, for instance by contacting a mobile marketing system from which the offer was generated. This can ensure not only that the code is valid but also other offer stipulations are satisfied (e.g., validity dates, other product purchases . . . ). At reference 2230, the promotional offer is honored for example by discounting the price of a product or service. Subsequently or concurrently, at 2240, notification is provided of offer redemption. For example, mobile marketing system or some other service can be notified. In one instance, a specific database can be updated to reflect the honoring of the offer.

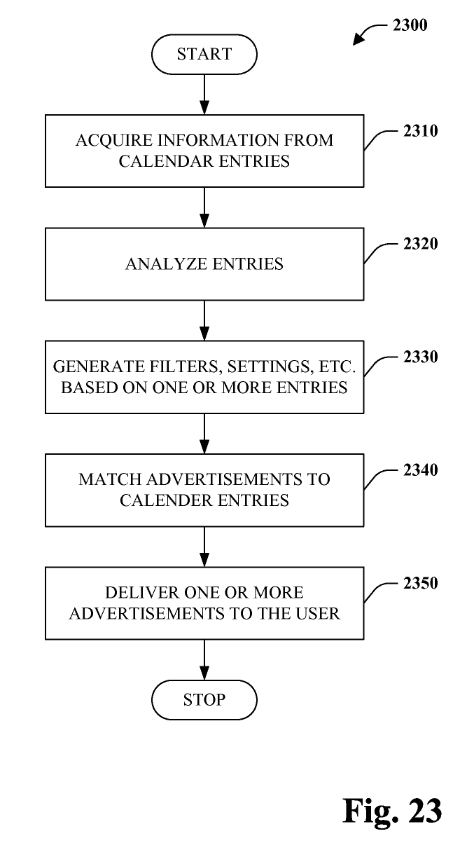

FIG. 23 is a flow chart diagram illustrating a method of advertising as a function of calendar entries in accordance with an aspect of the claimed subject matter. At reference numeral 2310, information is acquired or otherwise identified with respect to a calendar. In one implementation, utilizing a calendar (including calendars provided by a third party), events important to a particular user or otherwise can be captured. Moreover, additional information can be associated with an event. For example, not only can a child's birthday be noted on the calendar but it can also include information pertaining to gifts the child may like. Such products and services can be noted explicitly on such a date or filters or the like can be set that correspond to such products or services. Furthermore, the child can share his or her preferences with the user that can be associated with the date or a birthday wish list or the like can be linked to the date. At numeral 2320, calendar entries are analyzed and at reference 2330 filters, settings or the like are automatically generated based on one or more entries. Not only can filters be generated automatically to transform specifically or generally identified products or services into filters, but additional filters can be added that relate thereto. In this manner, filters can be added that identify potential items that may also be of interest. For example, if a child desires a particular gaming system, then filters can also be generated for associated games. Moreover, generation can be much more complex such that knowledge of interest in a gaming system can imply interest in a particular book for which filters can also be generated. At reference numeral 2340, advertisements are matched to calendar entries for example utilizing generated filters, settings or the like. At numeral 2350, one or more advertisements are delivered to the users at a predetermined time before and even on a particular date. Furthermore, it is to be appreciated that where calendar events employ shared lists, they can operate like a registry such that once someone has indicated that they have purchased something explicitly or implicitly by use of an offer for example, the item can be removed from the list and users will not be provided with coupons for such items.

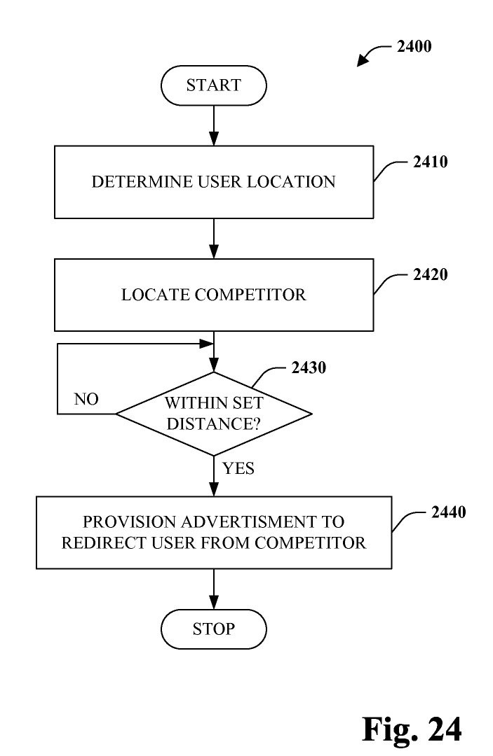

FIG. 24 illustrates a method of advertisement distribution 2400 according to an aspect of the claimed subject matter. At reference numeral 2410, a user's geographical location is determined. For example, location can be determined based on substantially real-time tracking via GPS for instance, utilizing proximity sensors, and/or network transmission triangulation, among other things. At reference 2420, a competitor or competing merchant is located. For example, a competitor's stores can be identified with respect to an address and/or coordinate system. At reference numeral 2430, a determination is made as to whether a user is within a set distance of an identified competitor. If no, the check continues on updated locations. If yes, an advertisement is provisioned to the user to redirect the user away from a competitor location at 2440.

By way of example and not limitation, consider two coffee shops “A” and “B,” where “B” is an advertiser subscribing to such a service. When a user approaches coffee shop “A,” they can be provided with an advertisement for coffee shop “B.” This is especially helpful to a user who prefers coffee shop “B” to coffee shop “A.” In this instance, an advertisement can be provided with a message identifying the closest location of coffee shop “B.” Where coffee shop “A” is also an advertiser subscribing to services described herein an auction can be held to determine whether an advertisement for coffee shop “A” or coffee shop “B” will be presented upon proximate location of a user.

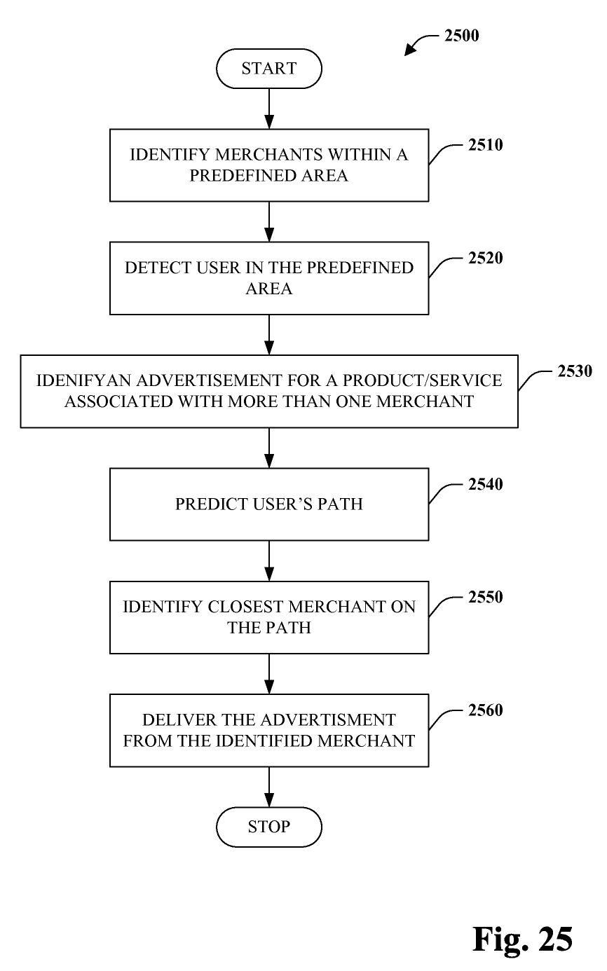

FIG. 25 depicts a method 2500 of advertising as a function of a behavior model in accordance with an aspect of the claimed subject matter. At reference numeral 2510, a number of merchants within a predefined area are identified. For example, such merchants can be mall tenants. At 2520, a user is detected within the predefined area. In the example, the user enters or approaches a mall. At numeral 2530, an advertisement for a product or service provided by more than one merchant is identified. A user's path is predicted based on a variety of factors including, among other things historical paths or behavior models. For example, one particular user may visit all stores on a first side and then all stores on a second side while a different user may prefer to visit stores in a zigzag pattern. At reference 2550, the closest advertising merchant on the user's path is identified. Finally, at 2560, the advertisement from the closest merchant is delivered to the user.

While location is a factor in generating a sale, location alone may not be enough. For example, consider a situation in which at the time an advertisement is identified the stores offering a desired product or service are equidistant from a user yet one merchant is behind the user and one merchant is in front of the user in terms of a particular route. For instance, maybe parking caused the user to enter from a different location than normal. It is more likely that an advertisement associated with a merchant on the user route will generate a sale rather than one that requires the user to backtrack or modify his/her route.

Furthermore, merchants within such a predetermined distance that sell the same or similar products or services can simply agree to such a distribution of advertisements or other schemes can be used. For example, merchants can enter into a revenue sharing situation such that a close merchant on a path shares a portion of the purchase cost with a distant merchant or a merchant of a user's path. In this manner, overall sales can be increased and all merchants benefit. Additionally or alternatively, an auction can take place such that an advertisement associated with the closest merchant on the path is not required.

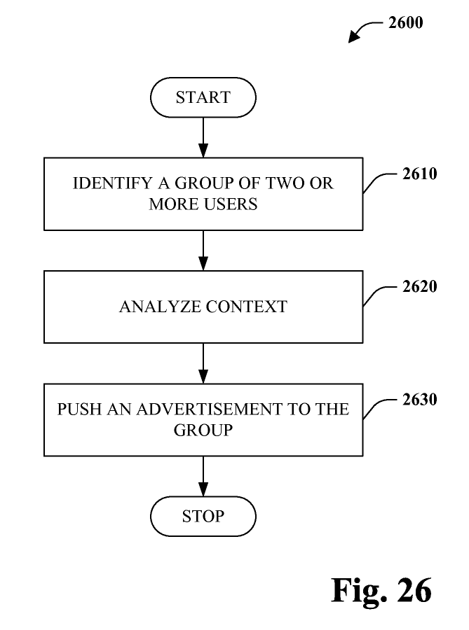

Referring to FIG. 26, a group advertising method 2600 is illustrated in accordance with an aspect of the claimed subject matter. At reference numeral 2610, a group of two or more users is identified. For example, based on GPS location, proximity sensor, or like data it can be determined that number of people or within a set particular distance of one another. At numeral 2620, context is analyzed including each individual's profile, settings and the like as well as other extrinsic information. Furthermore, it should be appreciated that context can include a determined or inferred group activity. Based on this analysis, an advertisement is pushed to one or more members of the group at reference numeral 2630. While the advertisement can simply promote a product or service or offer a discount upon purchase thereof, it can also be couched in more entertaining format so as to encourage the group to talk about it. For instance, it can be a funny video clip or image including reference to the advertiser and an option coupon or discount code.

By way of example and not limitation, consider a situation where a number of colleagues are conversing at the end of a workday. Based on their proximity they can be defined as a group. Thereafter, similarities can be analyzed to produce essentially a group profile, settings, and the like. In this case, it might be determined that the group is interested in beer specials associated with local bars and restaurants. Accordingly, advertisements associated there with can be matched. However, this can further be narrowed by extrinsic data such as the weather. If it is considered nice outside, namely warm and sunny, the advertisements can be further limited to establishments with outside patios. Further yet, if there is a basketball game, which one or more group members plans or would like to attend, then advertisements can further be linked to bars or restaurants close to the event. A matching advertisement can then be provided to one or more of the group members. In one instance, the advertisement can be provided to all group members to improve the effect of an advertisement. However, a group member may not be notified if they have another event that would conflict with meeting colleagues for drinks even though they otherwise would participate. Furthermore, the advertisement may only be provided to a determined group leader such as a supervisor, major or otherwise outgoing individual.

Among other things, the user dialog, disclosed herein, can be leveraged to obtain information regarding a mobile marketing system brand, advertisers' brands, advertisers' advertisements, and how they will be perceived in the marketplace. The central “general contractor” perspective of providing advertisements for advertisers allows the marketing system to see the competitive advantages that advertisers possess as compared to their competition. This central perspective enables the system to recommend advertisements that build these identified advertiser advantages into future marketing messages. Companies that apply this technique present a believable and consistent brand messages to their customers and several benefits are realized as a result.

First, marketing campaign effectiveness can increase with improved response rates. This can be accomplished by providing advertisers with pre-calculated micro segmentation (e.g., market segments, affinity groups) along with predictive analysis to support tactical advertisement generation.

Second, sales revenue can be increased in a number of ways. For instance, wallet share or the overall proportion of income designated for a merchant is increased for each customer. Additionally, cross selling and up selling opportunities are enhanced.

New markets or micro segments are also created for merchant products and services by fine tuning advertisements to satisfy more micro segments with slight alterations that completely match consumer desires. For example, alterations can include applying discounts to products of certain colors, quality, logos, sizes, and/or capabilities, among other things.

New customers can also be acquired by introducing an advertisers advertisement to members how recently entered a monitored micro segment or affinity group. This occurs over time, as a member's transaction history groups and the member continually specifies his/her needs. Further, unit margins can be increased with respect to old as well as new customers.

Furthermore, attrition is reduced for a number of reasons. First, loyalty is increase through active learning and relationship marketing, because it makes in more difficult for a member to expend time and effort searching for a competitor's offer that satisfies his preferences at the same level such as product, price, location, integration in lifestyle, etc. Second, customer service is inherently improved. In addition, an advertiser is provided with a competitive advantage over others since advertisements are tailored to an individual's preferences and integrated into daily lifestyle. Finally, customer satisfaction is increased with advertisements that recommend products and services that match the remembered member's preferences and purchasing trends.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Herein, the term “advertisement” is meant to refer to any form of communication seeks to attract attention to a merchant or one or more products or services of a merchant. For example, an advertisement can be a marketing message of arbitrary complexity designed to persuade customers to make a purchase. In one particular instance, an advertisement can include or correspond to a promotional offer. For example, a coupon offering a discount on a purchase from a merchant is an advertisement.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

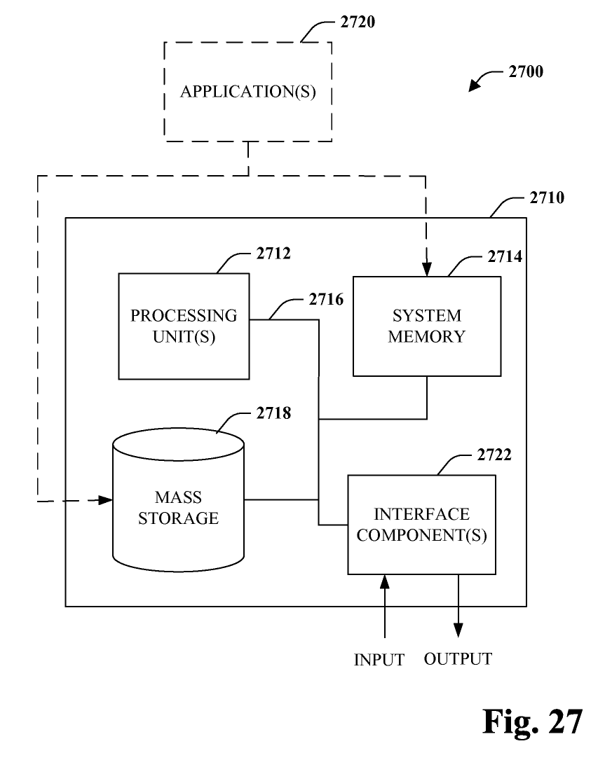

In order to provide a context for the various aspects of the disclosed subject matter, FIGS. 27-29 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 27, an exemplary environment 2700 for implementing various aspects disclosed herein includes a computer 2710 (e.g., desktop, laptop, server, hand held, programmable consumer or industrial electronics . . . ). The computer 2710 includes a processing unit 2712, a system memory 2714, and a system bus 2716. The system bus 2716 communicatively couples system components including, but not limited to, the system memory 2714 to the processing unit 2712. The processing unit 2712 can be any of various available microprocessors. It is to be appreciated that dual microprocessors, multi-core and other multiprocessor architectures can be employed as the processing unit 2712.

The system memory 2714 includes volatile and nonvolatile memory. Volatile memory includes random access memory (RAM), which can act as external cache memory to facilitate processing, among other things. Nonvolatile memory can include, without limitation, read only memory (ROM). For example, the basic input/output system (BIOS), includes basic routines to transfer information between elements within the computer 2710, such as during start-up, is stored in nonvolatile memory.

Computer 2710 also comprises mass storage device(s) 2718 of various types such as removable/non-removable and/or volatile/non-volatile for housing data. Mass storage 2718 includes, but is not limited to, devices like a magnetic or optical disk drive, floppy disk drive, flash memory, or memory stick. In addition, mass storage 2718 can include storage media separately or in combination with other storage media. By way of example and not limitation, mass storage 2718 can correspond to either or both of an internal computer 2710 store and removable store.

FIG. 27 provides software application(s) 2720 that act as an intermediary between users and/or other computers and the basic computer resources described in the suitable operating environment 2700. Such software application(s) 2720 include one or both of system and application software. System software can include an operating system, which can be stored on mass storage 2718, that acts to control and allocate resources of the computer system 2710. Application software takes advantage of the management of resources by system software through program modules and data stored on either or both of system memory 2714 and mass storage 2718. Accordingly, applications 2720 transform a general-purpose machine into a specific machine that executes particular functionality in accordance with one or more applications 2720.

The computer 2712 also includes one or more interface components 2722 that are communicatively coupled to the bus 2716 and facilitate interaction with the computer 2710. By way of example and not limitation, the interface component 2726 can be a port (e.g., serial, parallel, PCMCIA, USB, FireWire . . . ) or an interface card (e.g., sound, video, network . . . ) or the like. The interface component 2722 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer, and the like. Output can also be supplied by the computer 2710 to output device(s) via interface component(s) 2722. Output devices can include displays (e.g., CRT, LCD, plasma . . . ), speakers, printers, and other computers, among other things.

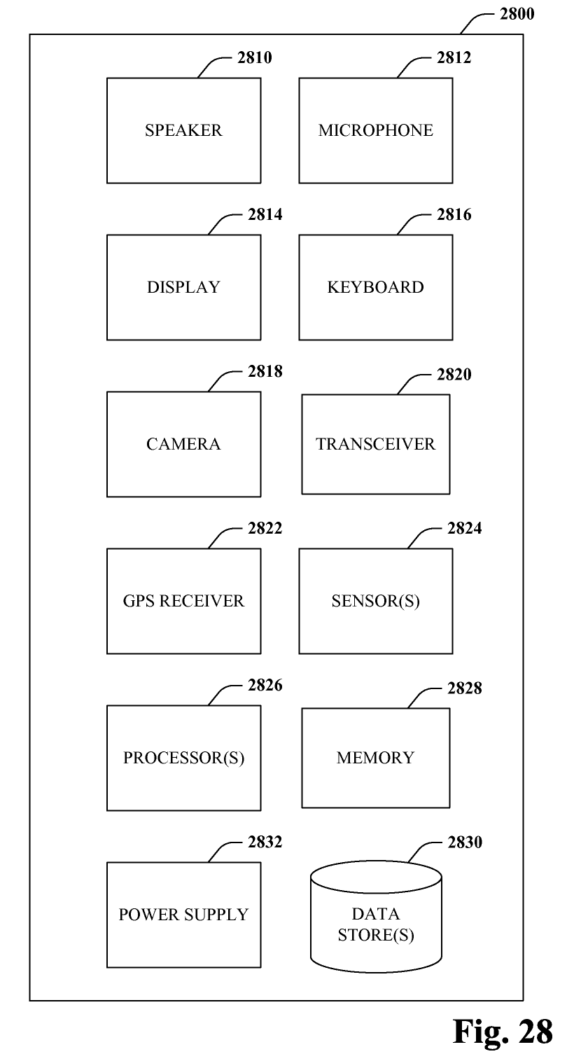

Turning attention to FIG. 28, an exemplary mobile computing device 2800 is shown that can provide a suitable operating environment of at least a portion of claimed aspects. As illustrated, the device 2810 includes at least one speaker 2810 and microphone 2812 for producing and recording audio, respectively. Display 2814 provisions a visual representation of data and information to a user of the device 2800 to facilitate use. In one aspect, the display can be touch-sensitive to enable device functionality to be accessed by touch. Of course, the device is not limited thereto and other means of access or interaction can be provided alone or in combination. For instance, the device 2800 can include a keyboard 2816 to input data and navigate device functionality. Other input mechanism are also possible but not shown include a mouse or trackball, among other things. The device 2800 can also include a camera 2816 to allow capture of pictures and/or video. The camera 2818 can also be associated with a light source to facilitate recording in low light situations.

Transceiver 2820 is a mechanism that enables communication of the device 2800 with other like or disparate devices, access points, and/or networks, among other things. The transceiver 2820 includes functionality for both transmitting and receiving wireless signals. Consequently, the transceiver 2818 can include, or be communicatively coupled to, one or more internal and/or external antennas (not shown). For example, the transceiver can enable voice communication over one or more telephone networks and/or data transmission (e.g., Bluetooth, Wi-Fi, WiMax . . . ).

The mobile computing device 2800 can also include a GPS (Global Positioning System) receiver 2822. The GPS receiver 2822 is able to locate and receive information from a plurality of orbiting satellites. From acquired information, the GPS receiver 2822 is able to compute its location, which can then be employed by the device 2800 or applications executing thereon to provide location dependent functionality (e.g., navigation). Additionally or alternatively, it should be appreciated that cellular transmissions can provide information as a function of signal strength and employment of one or more cell towers, for instance. Other location means or mechanisms are also possible including those associated with proximity and network access (e.g., IP address), among other things.

The device 2800 can also include one or more sensors 2824 for acquiring information pertaining to the device itself or its surroundings. For example, an accelerometer and/or gyroscope can be incorporated into a device to sense movement of the device. This information can then be utilized to aid device interaction. Other sensors 2824 are also possible including, inter alia, an altimeter for measuring altitude or height above a fixed level, a thermometer for quantifying temperature, a barometer for measuring pressure, a hygrometer for sensing humidity, an optical sensor for detecting light, a microphone for sensing sound, a smell sensor for identifying scents, and a proximity sensor for measuring distance from an object or entity.

The computing device 2800 also includes one or more processors 2826, memory 2828, one or more data stores 2830, and a power supply 2830. The processor(s) 2826 executes instructions local to the processor and/or housed in memory 2828 to perform some functionality dictated by a hardware and/or software program. The memory 2828 provides volatile and non-volatile storage of data and instructions for expeditious access by the processor(s) 2826. Data store(s) 2830 is a mechanism for persisting large amounts of data and instructions for later use. For example, the device can have an internal data store as well as mechanism to utilize a removable storage device such as a flash memory card or the like. Finally, the device 2800 can include a power supply to enable operation of its component such as but not limited to a rechargeable battery.

It should be appreciated components of the mobile device 2800 are merely exemplary and can vary as a function a mobile device type or configuration, among other things. For example, the mobile device can correspond to a mobile phone in one embodiment. However, the device can also be a personal digital assistant (PDA), electronic book reader, or a gaming system, which necessitate addition of components, removal of components and/or reconfiguration of components.

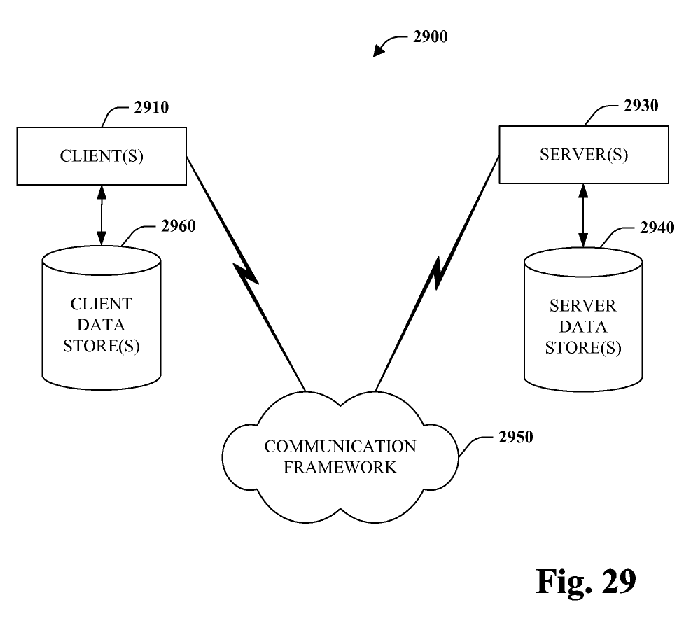

FIG. 29 is a schematic block diagram of a sample-computing environment 2900 with which the subject innovation can interact. The system 2900 includes one or more client(s) 2910. The client(s) 2910 can be hardware and/or software (e.g., threads, processes, computing devices). The system 2900 also includes one or more server(s) 2930. Thus, system 2900 can correspond to a two-tier client server model or a multi-tier model (e.g., client, middle tier server, data server), amongst other models. The server(s) 2930 can also be hardware and/or software (e.g., threads, processes, computing devices). The servers 2930 can house threads to perform transformations by employing the aspects of the subject innovation, for example. One possible communication between a client 2910 and a server 2930 may be in the form of a data packet transmitted between two or more computer processes.

The system 2900 includes a communication framework 2950 that can be employed to facilitate communications between the client(s) 2910 and the server(s) 2930. The framework 2950 can include one or more of many wired and/or wireless communication means including without limitation the Internet and cellular technologies, among others. The client(s) 2910 are operatively connected to one or more client data store(s) 2960 that can be employed to store information local to the client(s) 2910. Similarly, the server(s) 2930 are operatively connected to one or more server data store(s) 2940 that can be employed to store information local to the servers 2930.

Client/server interactions can be utilized with respect with respect to various aspects of the claimed subject matter. By way of example and not limitation, the client(s) 2910 can correspond to a user computer or mobile device such as a phone, which is able to communicate with a mobile marketing system or at least a subset of such functionality executed by one or more servers 2930 across the communication framework 2950. Further, the server(s) 2930 can afford a mobile application comprising mobile marketing functionality that can be downloaded over the communication framework 2950 and subsequently installed by the client(s) 2910. Further yet, all or portions of the mobile marketing system can be hosted by one or more servers 2930 and accessible via one or more clients 2910 including mobile and other computer devices to facilitate input consumer and advertiser information (e.g., profiles, preferences, setting . . . ), for example through an online website.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “contains,” “has,” “having,” or variations in form thereof are used in either the detailed description or the claims, such terms are intended to be inclusive in a manner similar to the term “comprising” as “comprising” is interpreted when employed as a transitional word in a claim.

What is claimed is:

1. A computer-implemented marketing system, comprising:
a dialog component that establishes an electronic dialog with a user to acquire discrete pieces of information and saves the acquired information to one or more data stores;
a correlation component that matches advertiser coupons to users as a function of at least to the acquired information; and
a delivery component that delivers an electronic coupon to mobile devices associated with matching users.

2. The system of claim 1, the dialog component acquires feedback about at least one of an advertiser or advertisement.

3. The system of claim 1, further comprising a question component that generates one or more user specific questions designed to retrieve information about a user's specific needs or desires.

4. The system of claim 3, further comprising a response component that analyzes a response to the one more questions and provides information to the question component to aid generation of subsequent questions as a function of previously responses to questions.

5. The system of claim 1, further comprises a component that provides an incentive to a user to engage in electronic dialog.

6. The system of claim 5, the dialog component is activated at a point of sale and an electronic coupon can be afforded in exchange for engaging in the dialog.

7. The system of claim 1, further comprising an analysis component that analyzes database data associated with individuals and classifies them into affinity groups or segments that are utilized by the correlation component to predicatively match coupons to users.

8. The system of claim 1, further comprising a component that analyses information in the database and identifies effective promotions.

9. The system of claim 8, further comprising a component that automatically generates a coupon for an advertiser based on an identified promotion.

10. A method of mobile marketing, comprising:
employing a processor executing computer executable instructions to implement the following acts:
presenting one or more one-off questions to a user on a mobile device as a function of current context;
storing responses to the questions to a database;
analyzing database data including the responses, user profiles, user preferences, and transaction history to identify micro segments; and
classifying users as members one or more micro segments.

11. The method of claim 10, further comprising requesting a user rate a product or service.

12. The method of claim 10, further comprising generating a question as a function of a response to a previous question.

13. The method of claim 10, further comprising providing the user with an incentive to respond to the one or more questions.

14. The method of claim 10, further comprising predicatively matching a promotional offer to a user as a function of a micro segments of which the user is deemed a member.

15. The method of claim 10, further comprising receiving a test advertisement and identifying a number of user matches produced by the advertisement.

16. The method of claim 10, further comprising identifying an unmet need and notifying an advertiser thereof.

17. The method of claim 16, further comprising automatically generating a promotional offer for an advertiser to address the unmet need.

18. A method of marketing goods or services, comprising:
employing a processor executing computer executable instructions to implement the following acts:
acquiring user profiles and preferences, electronic coupons, and advertiser preferences that control dissemination of the coupons;
monitoring transactional history of users with respect to the coupons including coupon notification, activation, and redemption;
classifying the users into affinity groups based on at least one of profiles, preferences, or transactional history; and
matching the coupons to users as a function of at least the group classification and advertiser preferences.

19. The method of claim, 18, further comprising engaging individual users in a real-time dialog based on current context and known information to acquire additional information to facilitate at least one of classifying the users or matching the coupons.

20. The method of claim 19, further comprising delivering the coupons electronically to mobile devices associated with the matching users.
